(19) United States
(12) Patent Application Publication
(10) Pub. No.: US 2007/0261579 A1
(43) Pub. Date: Nov. 15, 2007

(54) FIXTURE FOR ANTI-MARKING COVERINGS FOR PRINTING PRESSES

(75) Inventor: Daniel J. Rizika, Millbury, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: PrintGuard, Inc., Millbury, MA (US)

(21) Appl. No.: 11/747,355

(22) Filed: May 11, 2007

Related U.S. Application Data
(60) Provisional application No. 60/747,117, filed on May 12, 2006.

(51) Int. Cl. B41F 22/00

(52) U.S. Cl. 101/422

(57) ABSTRACT

A flexible anti-marking system for use on a printing press transfer cylinder is resilient to compressive forces. The system includes an outer flexible substrate layer having a textured surface protruding from a first side for supporting the freshly printed sheet material. The system further includes an inner flexible material that is resilient to compressive forces having an outer surface disposed in contact with the back side of the outer flexible substrate layer and an inner surface for contacting the transfer cylinder. A stiffening strip is mechanically fastened to a longitudinal edge portion, whereby the anti-marking system includes a stiffened longitudinal edge for fixturing to the transfer cylinder, the stiffened longitudinal edge comprising the stiffening strip and the longitudinal edge portion of the outer flexible substrate.

### RELATED APPLICATIONS

This application claims priority to U.S. Provisional Patent Application No. 60/747,117, filed May 12, 2006 and entitled Fixture for Anti-Marking Coverings for Printing Presses, which provisional application is hereby incorporated herein by reference.

### FIELD OF THE INVENTION

The present invention pertains to an improved anti-marking sheet and method for providing improved secured fastening to the press cylinder, providing for a form fit on the press cylinder and optimally supporting the freshly printed sheet material in a printing press or similar machine and, more particularly, to an improved fixture for an anti-marking cover for use on a cylinder in a printing press.

### BACKGROUND OF THE INVENTION

Since the first printing press was placed into operation, operators have wrestled with the problem of freshly printed sheets becoming undesirably marked as they travel from one printing station to the next. To solve this problem, press manufacturers and innovators have tried various methods ranging from tracking/skeleton wheels and pneumatic devices to cylindrical coverings of sandpaper, glass beaded paper, textured sheet metal and loose mesh fabric.

Traditionally, these antimarking systems were adhered to the transfer cylinder using a spray mount adhesive, double sided pressure sensitive tape, Velcro®, or even a removable pressure sensitive full backing to the system. Each printing press model requires a different means of attaching the antimarking system, and even within a press model, pressmen can choose which type of system they prefer to install. Some printing press OEMs provide a general mechanical attachment means such as a clamp, or plate that can be loosened so the longitudinal edge of the anti-marking cover can be slid under/into; and then the plate can be tightened down, securely holding the antimarking system in place.

Other printing press OEMs, such as Heidelberg, have newly designed mounting fixtures which require very accurate mating fixtures that are custom designed for the OEM's anti-marking cover. All of Heidelberg's anti-marking covers are made from one piece of sheet metal, the metal being embossed or treated with some ink repellent coating. The metal covers are die cut and formed (bent) to perfectly fit into the corresponding Heidelberg mechanical fixture on each press cylinder.

This means that Heidelberg designed the mechanical fixture on each press cylinder to optimally fit their textured sheet metal anti-marking covers, typically a thickness of 10-20 thousandths of an inch thick. The older embossed metal anti-marking covers do not have a suitable ink repellent coating and did not adequately prevent the sheet from marking, relying solely on the embossed texture.

Heidelberg improved these steel embossed anti-marking covers with their perfect jacket, which is a steel jacket with an easy clean coating that repels ink and performs very well on press. Problems with this jacket include its high cost and that it can be easily damaged by, for example, a miss-fed sheet of paper or a tool that falls on it surface. Once dented, the steel jacket cannot be repaired and permanently impairs the easy clean coating and causes ridges in the metal jacket that cause the portion of the freshly inked sheet that corresponds to the dent to mark/smear as it travels over the transfer cylinder cover and onto the next printing station.

Superblue® is the trademark of Printing Research Industry (PRI) which has a blue cheese cloth that is typically affixed to the press cylinder or under jacket containing Velcro® hook; the cheesecloth surface has tiny loop fibers that mimic the Velcro® loop and adheres to the Velro® hook. The Superblue® system relies on the movement of the net in conjunction with the freshly inked sheet of paper as it moves through the press. Superblue® nets are also treated with an ink repellent coating to aid in the transfer of the inked sheet without marking. Most recently, Superblue® introduced a jacket for the SM-74 press that follows the same concept as the Heidelberg steel jacket with the modification that the Superblue® net is affixed to a plain sheet metal steel under jacket using double sided tape. The fixture method for their steel under jacket is nearly identical to Heidelberg's, posing no fixturing difficulties.

Newer presses offer higher automation and higher speeds, coating stations, UV curing stations, Computer to Plate technology, the option to perfect and even enhanced auto cleaning of ink and blanket cylinders. These advances enable the modern pressman to print a job much quicker and change over from one print job to the next much faster. Limitations of the past were lifted only to expose new problems surrounding the transfer of the wet inked sheet from the first color station all the way through the press to the exit. As more wet ink/coating is put down on a sheet, coupled with the faster speeds, the paper becomes more difficult to transport mark free through the printing press. These changes bring about the opportunity for improved products on all press cylinders (transfer, delivery, perfector, coater/blanket, plate, and impression).

To solve the increased marking problem, some OEMs developed a transfer cylinder that uses rotational air to prevent marking, trying to solve marking by taking a radically new approach that requires no antimarking sheet. Technical limitations have generally prevented OEMs from offering this type of transfer cylinder on perfecting presses. Perfecting press are in high demand since they flip the sheet over automatically to allow for wet ink printing on both sides of the paper in one pass. Pressmen who operate these new presses recognize the need for an economical antimarking system that allows them to print with minimal downtime mark free.

The printing market is truly global; and since every country printed material in its native language suited to local needs, these new presses are purchased for use world wide. Climatic conditions are as varied as the chemical cleaners that each country authorizes for press cleanup. To optimize an antimarking system today, the manufacture must design a robust product that will withstand frozen temperatures to very hot temperatures, from dry to very moist humidity, from press chemicals that are water based to harsh solvent based.

Frequently there are technical or product limitations, economic tradeoffs, or press constraints that prevent a truly optimal product from being designed, made and successfully sold. Other times the limitations were not initially identified in the first products made, but later identified by the results of product testing on press under a myriad of environmental conditions.

While most of these anti-marking devices are effective to some degree, none of them fully satisfy the needs of a printer. A brief history illustrating the development of such anti-marking systems is outlined below.

In U.S. Pat. No. 2,085,845, Binkley applies “a coating granular material such as silicon carbide, emery, etc.” onto the face of the fabric which has a barrier coating adhered onto rear side and is adhered to the make-ready and then clamped to the tympan roll. Here, Binkley asserts that using a sandpaper-like material will provide the advantage of decreasing the marking of freshly printed sheets. In U.S. Pat. No. 2,555,319, Cross also studies the application of granular materials to rolls within a printing machine and tests granular materials ranging from glass culets, silicon carbide and aluminum oxide and compares them to spherical glass beads. He asserts that the spherical glass beads offer a smooth and round uniform surface that is superior to that of granular grit. Cross further asserts that spherical beads allow the freshly printed/inked sheet to be uniformly supported by the tops of millions of uniform glass beads resulting in a decrease of marking printed sheets. Cross also teaches of both the benefits of back coating a porous substrate and over-coating the beaded side to improve adhesion of the glass beads to the substrate as well as to aid in repelling printing inks/solvents.

In U.S. Pat. No. 4,694,750, Greene attempts to improve on known rolls having granular surfaces by using “an elastic member that is attachable to each flange and is stretchably positionable around the circumferential granular surface.” Greene's use of elastic bands to make an easily installable anti-marking product falls short in two areas: first the elastic bands impede use of the full width of the cylinder (thus limit sheet size). Second, since the elastic bands run circumferentially around the cylinder, they do not provide adequate uniform tension across the entire sheet resulting in movement of the granular sheet and ultimately marking results.

In U.S. Pat. No. 4,688,784, Wirz employs perforations in various textured surfaced anti-marking sheets that come into alignment with a hole or bore of the air ducts in the cylinder. The purpose of using compressed air is to aide in the transport of the freshly printed sheet as it travels mark-free from one printing station to the next.

In U.S. Pat. No. 3,791,641, DeMoore uses an ink repellent PTFE sheet that is affixed to skeleton wheel. Later, in U.S. Pat. No. 4,402,267, DeMoore improves upon this design by adding “a loosely retained ink repellent fabric covering” known in the industry as SUPER BLUE® over the cylinder sheet. In U.S. Pat. No. 5,842,412, Greenway et al. also uses a light weight fabric with preferred axial air permeability not less than about 0.138 cfm and a surface structure with closely spaced features of a spacing not more than about 0.125 inch.” This fabric is known in the industry as QUACK®.

In U.S. Pat. No. 5,088,404, MacConnell et al. addresses marking issues associated only with the delivery cylinder that removes sheets from the printing operations and delivers them to an exit stack. MacConnell et al. designs a delivery apparatus that allows a mechanical pivot to either increase or decrease the surface area of the delivery cylinder to allow for various size sheets. The pivot design is aided by a large open cell reticulated foam ¼″ thick (sponge-like) used as backing upon a traditional glass bead film sheet that allows the pivot arm to move without adjusting the bolted on glass bead covering. The MacConnell et al. design does not call for any special top coatings over the glass bead film. Furthermore, the sponge-like large holed ¼″ foam, when installed according to preferred instruction “acts to reduce the pressure between the sheet 29 and the delivery apparatus 11 by providing some compressibility to the delivery apparatus outside surface. The foam will compress under pressure from the sheet.” In other words, during normal press operation, the sheet can compress the reticulated foam due to it large open cell structure. This is the downside of the reticulated foam which if used according to the preferred embodiment on any other press cylinder, would not allow sufficient gap between the transfer and impression cylinders. The preferred ¼″ inch reticulated foam would require that the freshly inked wet sheet of paper compress the reticulated foam glass bead covering in such a manner that would result in increased marking, not decreased due to increased surface contact and friction. The reason why this method works on the delivery cylinder is solely because the MacConnell delivery apparatus has an adjustable or pivot able edge which requires ¼″ reticulated foam to allow movement without having to change the glass bead cylinder jacket as one pivots the leading edge of the delivery apparatus. Furthermore, the reticulated foam possesses large open holes which allow cleaning solvents to easily get under the jacket and reduce the effectiveness of the delivery apparatus.

In U.S. Pat. No. 5,102,744, Wirz et al. discloses a more economical method of making a metal foil jacket for the press cylinders of printing machines. Wirz first roughens the surface of the metal foil, followed by electroforming from a master pattern followed by metal plating. These sheet metal jackets are textured with a chromium layer which has good solvent resistance, however the surface has poor ink repellency. Another deficiency is that the sheet metal is easily dented and once dented cannot be repaired.

In U.S. Pat. No. 6,203,914 B1, Sudo et al. follows Cross's process for manufacturing an ink repellent anti-marking sheet as disclosed in U.S. Pat. No. 2,555,319. Sudo uses a urethane cross linked silicone top coat well known in the industry and disclosed in U.S. Pat. No. 5,415,935 as an ink-repellent coating over the glass beaded surface.

In U.S. Pat. No. 6,244,178 B1, DeMoore recognizes the importance of easy installibility and further improves his Superblue®. fabric to include asserted improvements such as pre-stretched, pressed flat and pre-cut to the cylinder dimensions complete with anti static/conductive filaments and ink-repellent coating. This pre-stretched, pressed flat net is adhered using double sided tape to their uncoated steel jacket that fits on the SM-74 Heidelberg transfer cylinder.

In U.S. Pat. No. 6,766,738, Blumm et al. discloses a method of producing an easy clean layer on a sheet metal jacket for a printing press. This product is believed to be the anti-marking jacket that Heidelberg sells under the trademark Perfect Jacket. The Perfect jacket has a much improved easy clean top coating and works well in the marketplace. The primary deficiency is that the jacket is made out of sheet metal and as such is easily dented when a sheet of paper is miss-fed, or a tool is dropped on it. Once dented the jacket cannot be repaired.

In U.S. Pat. No. 6,811,863 B1, Rizika improves the old glass bead and/or textured technology with an improved low surface energy top coating, and added a compressible flexible microcellular backing to this sheet trademarked PrintGuard®. The majority of the early transfer cylinder covers were made for the Pre-1994 Heidleberg printing presses with excellent results. Most of these products were classified as loop to loop cylinder covers, where the loops were mechanically sewn on each edge of the anti-marking cover.

Post 1994, Heidleberg improved the design of their transfer cylinders to accommodate their chrome foil and perfect sheet metal jackets. This dramatically changed the cylinder fixtures employed to secure transfer cylinder covers to their transfer. Early product designs were tested on machines under various environmental and cleaning conditions and found to have shortcomings.

### SUMMARY OF THE INVENTION

The present invention provides improved mechanical fastening for securely attaching an anti-marking cover to a press cylinder for supporting and conveying sheet or web material that has been freshly printed on at least one side wherein the printed material is supported by a cylindrical roll or skeleton or tracking wheels which has mounted on the outer surface thereof an anti-marking cover having at least two layers. The anti-marking material comprises at least an outer textured surface layer and an inner microcellular layer. The outer textured surface layer provides the surface that supports the wet printed sheet.

In one aspect of the present invention, a method is provided for easily and quickly affixing an anti-marking jacket to a press cylinder. The process begins by precutting a textured surface anti-marking sheet to the proper sheet dimensions for a given cylinder. Depending on the press model and cylinder location, a suitable mechanical fixture is mounted to the edge of the anti-marking cover for secure clamping into the OEM's mechanical fixture.

In accordance with another aspect of the present invention, a method of securely fixing an anti-marking cover to the transfer cylinder where at least one longitudinal edge of the anti-marking cover is mechanically fixed to a semi rigid strip of material by capping both sides of the transfer cylinder's cover edge thereby providing sufficient rigidity, the semi-rigid strip material is extruded, or mechanically bent in approximately half along the long axis (“V/U” like), the full length of the anti-marking cover's longitudinal edge. An adhesive is optionally used to temporarily secure semi-rigid “V/U” strip to anti-marking cover's longitudinal edge while a machine is used to crimp the “V/U” strip securely to the edge. Rivets or Eyelets are optionally used to permanently secure the “V/U” strip to the anti-marking cover longitudinal edge. Alternatively, ridges or teeth can be preformed in the “V/U” to permanently secure the edge. It is preferred that the total thickness of the mechanical fixture (to include rigid strip of material and anti-marking cover's longitudinal edge) does not exceed 150 thousandths of an inch. This design calls for the rigid part of the transfer cylinder cover's longitudinal edge not extend above the top surface of the transfer cylinder, allowing the flexible portion of the anti-marking cover to make the bend around the upper part of the transfer cylinder such that an easy form fit along the entire length of the cylinder's edge is obtained.

In accordance with another aspect of the present invention, a method of securely fixing an anti-marking cover to the transfer cylinder where at least one longitudinal edge of the anti-marking cover is sewn upon itself or to a semi rigid strip of material thereby providing necessary thickness and rigidity to securely fit into the OEM fixture. An adhesive is optionally used to temporarily secure the longitudinal edge upon itself or the optional semi-rigid strip to anti-marking cover's longitudinal edge prior to mechanical sewing. It is important in at least some embodiments that the total thickness of the mechanical fixture (to include rigid strip of material and anti-marking cover's longitudinal edge) does not exceed 150 thousandths of an inch.

In at least some embodiments, the rigid part of the transfer cylinder cover's longitudinal edge does not extend above the top surface of the transfer cylinder, allowing the flexible portion of the anti-marking cover to make the bend around the upper part of the transfer cylinder such that an easy form fit along the entire length of the cylinder's edge is obtained.

In yet another embodiment of the present invention, separate mechanical fasteners were substituted with the melting of two similar materials to form a permanent physical bond to mechanically fasten the layers. Spot welding the “V” shaped metal strip to secure the edge of the anti-marking cover and ultrasonic/RF welding of the edge of the anti-marking cover upon itself are also viable methods to achieve a secure fixture edge that fits into the OEM's fixture. Alternatively, ultra sonic welding a Plastic “V” or plastic strip is possible.

In another embodiment, a hook and loop type fastening strip (referred to throughout the present application by the preferred trade name of one preferred hook and loop fastener material: Velcro®) can be adhered to the longitudinal edges of the anti-marking sheet and mechanically affixed to a cylinder having a mating portion of Velcro® affixed along its longitudinal edges. Alternatively, a fibrous Velcro® backing can be adhesively adhered to the base of the anti-marking sheet and be mechanically affixed to the tracking/skeleton wheels having a mating portion of Velcro® affixed along the edge of its circumference.

In accordance with another embodiment of the present invention, a method for easily and quickly affixing an anti-marking cover to a transfer cylinder is provided. In one particular embodiment, the anti-marking cover is placed, for example, on the transfer cylinder of a Heidelberg Speedmaster 102 printing press using a reusable SM-102 Rivet Bar (for example, 10 dome shaped rivets mechanically fixed and protruding from one side of a steel bar and Velcro® hook affixed onto the other side of the steel bar). This anti-marking cover has the mating Velcro® loop mechanically fixed to one longitudinal edge and an stretchable loop on the other longitudinal edge. The operator first attaches the reusable Velcro® loop side to the Velcro® Hook side of the reusable SM-102 Rivet Bar. The pressman next snaps the dome head rivets into the mating spring bar mechanical fixture on the Heidelberg SM102 transfer cylinder. The pressman rotates the cylinder until the stretchable loops align with the OEM mechanical fixture at the other side of the cylinder. The pressman snaps the stainless steel rod (held by the stretchable loops of the anti-marking cover) into the mating OEM fixture and then pushes down on the flipped up portion of the cylinder to tension the loops and anti-marking cover. Lastly, the lockdown bolts are tightened.

In accordance with another embodiment of the present invention, a further method for easily and quickly affixing an anti-marking jacket to a transfer cylinder is provided. In this method, an anti-marking jacket can be placed on the transfer cylinder, for example, of a Heidelberg Speedmaster 74 printing press using reusable SM-74 Pin Bar affixing hardware. In one example, a rigid piece of sheet metal or plastic is die cut to fit over the eight circular pins that protrude from the transfer cylinder. Along one edge of this rigid piece Velcro® hook is affixed. An anti-marking cover can have the mating Velcro® loop mechanically fixed to one longitudinal edge and one of the above mentioned mechanical fixtures is attached to the other longitudinal edge. The operator first attaches the reusable Velcro® loop side to the Velcro® Hook side of the reusable SM-74 Pin Bar. Optionally, one may install a lock device to prevent the reusable die cut piece of material with Velcro® hook from ever moving off the 8 circular pins. Next, the pressman inserts the flat side of the mechanically fastened stiff longitudinal edge of the anti-marking cover into the mating mechanical fixture on the Heidelberg SM74 transfer cylinder. The pressman rotates the cylinder until the reusable SM-74 pin bar hardware with Velcro® hook aligns with the OEM mechanical fixture at the other side of the cylinder. The pressman snaps the eight die cut areas over the eight circular pins, ensuring the lower edge of the die cut material fits securely under the lips of the circular pins. Next the pressman uses an appropriate wrench to tension the jacket until tight. The pressman next inspects the anti-marking cylinder cover for proper form fit.

A person of ordinary skill in the art will understand that there are other means for constructing a reusable mechanical fastening within the spirit of the present invention and, in particular, applying the aspect of this invention that involves a two part anti-marking cover, where one longitudinal edge contains the mechanical fixture that fits directly into one end of the press cylinder; and the second longitudinal edge contains the mechanical fixture that fits directly into the second end of the press cylinder, and the two parts mate back together to form one anti-marking cover.

It should further be understood that both the SM102 and the SM74 reusable “two piece” anti-marking covers can be manufactured as a disposable one piece anti-marking cover by not installing the Velcro® hook/loop connection, and instead mechanically securing the anti-marking sheet to each longitudinal edge fixture, preferably with rivets/eyelets.

### BRIEF DESCRIPTION OF THE DRAWINGS

Other objects, features, and advantages of the present invention will be explained in the detailed description of the invention below, having reference to the following drawings in which like element numbers refer to like elements:

FIG. 1 is an illustration of a six color offset perfecting printing press highlighting the press cylinders upon which an anti-marking sheet of the present invention is applied;

FIG. 2a is a cross-sectional view showing the layers of material of an anti-marking sheet of the invention covering the circumferential surface of a press cylinder (delivery, transfer, perfector, blanket, coater, or impression) of FIG. 1;

FIG. 2b is a cross-sectional view of an alternative construction of the anti-marking sheet of FIG. 2a using glass beads as the textured surface;

FIG. 2c is a cross-sectional view of FIG. 2b, after the microcellular layer has been removed exposing the textured surface with plain film backing in preparation for the mechanical fixture to be attached;

FIG. 2d is a cross-sectional view of FIG. 2c with a semi-rigid material mechanically affixed;

FIG. 3 is a diagram of a press cylinder fitted with an anti-marking cover with the improved mechanically fastened stiff longitudinal edges of the present invention;

FIG. 4 is a diagram of a one step jacket of the invention that mounts on a Heidelberg SM-74 printing press;

FIG. 5a is a cross-sectional view of the reusable SM102 rivet bar that has 10 custom rivets protruding from one side, and an improved Velcro® hook strip on the other side that removably attaches to the mating Velcro® loop side of the anti-marking cover of the present invention;

FIG. 5b is a back view of the reusable SM102 rivet bar that shows the rear side of the fastened 10 custom rivets, and the improved Velcro® hook strip that attaches to the mating Velcro® loop side of the anti-marking cover of the present invention;

FIG. 5c is a front view of the reusable SM102 rivet bar that shows the front side of the dome shaped 10 custom rivets, and an optional material such as fabric that covers the steel bar the dome shaped rivets are mounted to;

FIG. 5d is a diagram of the anti-marking cover with loop Velcro® on one edge that mechanically attaches to the rear side of the present invention;

FIGS. 6a and 6b are cross-sectional views of the reusable SM-74 pin bar with eight die cut openings, and an improved Velcro® hook strip on the lower side that removably attaches to the mating Velcro® loop side of the anti-marking cover of the present invention; FIG. 6a consists of two pieces of Stainless steel with eight die cuts and a ninety degree bend for improved rigidity; FIG. 6b is a single piece of stainless steel with the eight die cuts and Velcro® hook mechanically attached;

FIGS. 6c and 6d are front views of the reusable SM-74 pin bar with eight die cut openings, and an improved Velcro® hook strip on the lower side that removably attaches to the mating Velcro® loop side of the anti-marking cover of the present invention;

FIG. 6e is a diagram of the anti-marking cover with loop Velcro® on one edge that mechanically attaches to the rear side of the present invention;

FIG. 7a. is a cross-sectional view of mechanical fixture the securely fastens the anti-marking cover along the longitudinal edges with a strong magnet so it may be easily installed or removed from the lead and tail longitudinal edges of the metal press cylinder;

FIG. 7b is a diagram of an antimarking cover that is affixed using an improved magnet mechanically fastened to the longitudinal edges of the antimarking cover;

FIG. 7c is a cross-sectional view of mechanical fixture the securely fastens the anti-marking cover along the longitudinal edges with Velcro® so that it may so it may be easily installed or removed from the corresponding Velcro® fastened to the lead and tail longitudinal edges of the metal press cylinder;

FIG. 7d is a diagram of an anti-marking cover that is affixed using an improved Velcro® mechanically fastened to the edges of the antimarking cover;

FIG. 8a has several options for cross-sectional views of prepping the longitudinal edge of an anti-marking sheet of the present invention to fit into a rigid bar for attachment to a press cylinder;

FIGS. 8b, 8c and 8d depict a cross-sectional view three alternatives for mechanical fastening the edges of an anti-marking sheet of the present invention so it may be securely mounted onto a press cylinder; and

FIG. 8e is a diagram of the anti-marking cover with permanent bars on each edge that mechanically attaches to the lead and tail longitudinal edges of the present invention.

### DESCRIPTION OF THE PREFERRED EMBODIMENTS

The present invention relates to anti-marking coverings for use in printing presses, and, in particular, the fixturing of anti-marking coverings to cylinders used in printing presses. To the extend that such fixturing has been addressed in the art, it has generally addressed the mechanical fixturing hardware and method of producing it. However, the best fixtured longitudinal edges of the anti-marking cover do not prevent marking by themselves. The contact between the outer textured surface and the wet printed ink is important to anti-marking performance. Too much surface or uneven contact will cause the wet ink to smear or mark. Too little surface or uneven contact will cause the sheet to be inadequately supported (resulting again in marking) as it is transferred from one printing station to the next. The pattern of the textured surface is therefore preferably uniform across the entire surface and strikes a delicate balance between adequate support for and good release of the wet printed sheet without marking.

In the illustrated embodiments, flexible anti-marking systems are described, made, and used. In general, these anti-marking systems include two layers: an outer layer having a textured surface for supporting a freshly printed sheet and an inner flexible material that is resilient to compressive forces. Such a system is sometimes referred to herein as a “two plus layer” system, indicating that the two layers can be present, and also that optional coatings may be provided in addition to the two layers. A stiffening strip can be mechanically fastened to the anti-marking system to create a stiffened longitudinal edge for further fixturing to a printing press cylinder.

With no limitation on the invention intended, an optimal anti-marking system according to the invention preferably meets the following four conditions:

1. Function: The outer surface of the anti-marking system should perform its function of uniformly supporting and conveying the freshly printed sheet from one printing station to the next without marking the freshly printed sheet. To optimally repel printing inks and coatings, a low surface energy coating is recommended to reduce the surface tension of the textured profile of the anti-marking cover.

2. Secure Installation: The anti-marking cover should be installed securely to the press cylinder so that even under adverse environmental conditions it does not come off the press cylinder and thereby damage the printing press. The anti-marking cover is preferably designed so that it can be easily installed to each type of printing press with minimal effort and time required by the pressman. It can be important to design a suitable longitudinal edge fixture for a non-steel antimarking cover to fit securely into the OEM's fixture which was designed for a steel jacket.

3. Fit: The anti-marking cover should fit precisely onto the press cylinder in such a manner as to allow for a form fit to the press cylinder. Preferably, the compressible microcellular layer will slightly compress during installation. When properly aligned with the press cylinder's mechanical fixture, the longitudinal edge of the anti-marking cover should easily slide into the clamping mechanism. With the first longitudinal edge of the anti-marking cover clamped securely in the OEM fixture, the pressman rotates the press cylinder allowing the anti-marking cover to wrap around the cylinder until the other longitudinal edge of the anti-marking cover is aligned with and secured in OEM mating clamp on the other side of the press cylinder.

A properly installed anti-marking cover will conform to the outer surface of the cylinder without any ridges, bubbles or creases which by themselves create undesirable marks. A two plus layer system optimizes the fit of the anti-marking cover to the press cylinder, in particular in the area of the 90-180 degree bends around the lip of the lead/tail portions of the press cylinder. Rigid materials do not make these sharp bends well, typically leaving either a ridge or bubble at the turn which results in marking or smearing of the freshly printed wet ink. The two plus layer system can make the turn from the OEM's mechanical fixture to the surface of the press cylinder by conforming to the shape of the cylinder without any bubbles or ridges.

4. Durability: If necessary, the anti-marking surface should be easily cleaned with a mild press wash upon completion of the printing job to remove ink and oil residue from the printing machine. The anti-marking product should withstand contact with hundreds of thousands of printed sheets of various thicknesses, as well as the inadvertently dropped tool or creased/folded sheet which typically can damage an anti-marking cover. The two plus layer system can reduce damage to the anti-marking cover, providing for an optimal mark free system.

The benefit of a mechanically fastened stiff longitudinal edge for a two plus layer anti-marking cover, is that it resolves the aforementioned shortcomings of prior art. The steel cylinder jacket shortfall is that it is made out of steel and thus is easily dented during operation of the press. Once dented, the steel jacket cannot be repaired and can no longer adequately perform its intended purpose of preventing marking. Yet another shortfall is that at least one edge of the steel jacket requires a 90 degree bend. The short end of the bend fits perfectly into the Heidelberg mechanical fixture on the inside edge on the press cylinder. However, the 90 degree bend in the steel means that the steel material cannot form fit to the contour of the cylinders edge as it transitions from the fixture to the top part of the cylinder. The point from exiting the clamp to making the imperfect 90 degree turn to the main (top) portion of the cylinder is a critical area where ink smearing/marking occurs.

One benefit of the present invention over this prior art, especially when it is provided in a “two plus layer” format, can be that it solves both of these shortcomings, and for the first time securely fits into the Heidelberg mechanical fixture that was designed specifically for the steel jacket. The “two plus layer” consists of the textured layer with optional low surface energy coatings on top that repels ink to prevent marking, and a bottom layer that is resilient to compressive forces (sometimes referred to as a “microcellular layer” in preferred embodiments) that allows for a flexible form fit to the contour of the press cylinder. The microcellular bottom layer also allows for a form fit to the entire surface of the cylinder, and provides both strength and resiliency to the textured coating so when a sheet is miss fed through the press the microcellular layer allows temporary deformation of the top layer so that no permanent damage occurs to the anti-marking cover's functionality.

In the illustrated embodiments, a textured surface that contains uniform raised contact points spaced apart by lower areas is preferred. For embossed patterns, the percent area of the raised ridges should preferably not exceed about 60% or the contact area with the wet printed sheet will not release cleanly without marking. The percent area of the raised contact can be minimized by careful tooling of the embossing roll. Care should be taken to uniformly space the raised contact points while minimizing their surface area. The minimum area in this scenario approaches zero and is constrained only by current manufacturing processes to single digit percentages.

In further aspects of the present invention, there is provided a method and apparatus for supporting and conveying sheet or web material that has been freshly printed on at least one side wherein the printed material is supported by a cylindrical roll or skeleton/tracking wheels which has mounted on the outer surface thereof an anti-marking material comprising an outer glass bead textured surface layer and an inner microcellular layer. In this embodiment, the textured surface is created by adhering glass/zirconia/plastic beads uniformly to the outer surface. Here, only the convex portions of the glass beads come in contact with the wet printed sheet. Glass beads are extremely durable and provide an excellent uniform surface to support the sheet while allowing for any excess ink to slide down the glass bead and collect in the low areas between the bead peaks.

The inner microcellular layer is a preferred compliment to the textured surface for the illustrated embodiments as an inner flexible material. When adhered to the planar or flat underside of the textured surface, the microcellular layer conforms to the outer surface of the cylinder ensuring a perfectly uniform outer textured surface. The key features of the microcellular layer are that it is both compressible and resilient. In one embodiment, a five pound/cubic foot polyolefin microcellular foam was extruded and laminated to the planar surface. In another embodiment, a thirty pound/cubic foot urethane microcellular foam was extruded and laminated to the planar surface. In yet another embodiment, a rubber saturated paper was laminated to the planar surface. In all these cases, the microcellular layer provided the required compression under weight/pressure and were sufficiently resilient when the weight/pressure was removed.

As noted, the build up of ink can be prevented on the textured surface through the use of an ink-repellent coating applied thereon. In one embodiment, the ink-repellent coating is a cross-linkable silicone or fluorocarbon. Still further, in accordance with another embodiment of the present invention, the buildup of static or electrical charge on the textured surface can be prevented through the use of either conductive coatings or an anti-static coatings applied thereon to one or both sides of the anti-marking sheet. Conductive coatings can be metal foils or metallized substrates. Anti-static coatings are preferably salt based. In order to effectively dissipate static electrical charges, it is critical to ground the surface of the anti-marking material to the cylinder or some other suitable ground.

A person of ordinary skill in the art will also understand that it is possible to employ the spirit of the present invention using a coated textured film and applying commercial packing or microcellular packing under the textured or glass beaded film cover to achieve similar results. The two plus layer anti-marking cover simplifies installation and improves overall anti-smearing results.

One problem that can be encountered is securely fastening the two plus layer anti-marking cover's normally flexible thick longitudinal edge into the cylinder fixture's slot which was designed to receive a rigid thin steel anti-marking cover. The two plus layer is approximately three times the thickness of the OEM's steel anti-marking covers. Furthermore, the flexible nature of the two plus layer anti-marking cover is very different from the rigid steel cover. The thinner and more rigid the anti-marking cover's edge is, the easier it is to fit into the aforementioned mating fixture located on the edge of the cylinder.

One way to address this difficulty in applying a two plus layer anti-marking cover is to transform the longitudinal edge of the cover into a single top layer (textured surface outer layer) only along the cover's longitudinal edge that fits into the clamping fixture. Next a semi-rigid material is adhered to the non-textured side of the surface. The above process transforms the thick floppy longitudinal edge of the two plus layer cover into a thin semi-rigid edge that mimicked the edge of the OEM's steel ant-marking cover's longitudinal edge. This product fits well into the OEM's fixture, and the fixture can be fully engaged (clamped). At first, this product modification seemed to pass all four conditions outlined above.

Extensive testing under varied environmental conditions encountered in various global countries (temperature, humidity, various chemical press washes, etc.) showed, however, that the installation was not always secure. Failures occurred at the junction of the semi-rigid strip to the rear surface of the textured layer. Over time, harsh solvent press washes coupled with high humidity and high temperature under high shear cause the adhesive that bonded these two layers to fail. Several new adhesives were tested with improved results; however, no adhesive could guarantee that these two layers would not separate.

There are at present no mechanical fixtures for attaching anti-marking sheets as described herein to the newer Heidelberg presses using the flat bent metal jackets fixture method. Both OEM and other anti-marking manufacturers employ either sheet metal jackets, or their antimarking cover relies solely on an adhesive to connect the anti-marking cover's edge to the rigid structure that fits into the OEM's cylindrical fixture. No one has yet solved this problem in providing a two plus layer anti-marking system under these circumstances.

The present invention can provide several new methods of attaching the semi-rigid material to a longitudinal edge of an anti-marking cover. The OEM's fixture on the cylinder severely limits the thickness of the longitudinal edge of our two plus layer anti-marking cover. Additionally, the gripper pads further reduce the physical placement of any mechanical fixture employed to permanently bond the two longitudinal layers together. Furthermore, the type of mechanical fixture employed could adversely affect the form fit of the two plus layer anti-marking cover as the transition from fixture to top of cylinder was navigated (over the 90 degree bend).

At least the following mechanical methods, described in greater detail below, worked well and are viable options for securely fixing the longitudinal edge of the anti-marking cover into the OEM's mechanical fixture: 1) Mechanically applying Rivets/eyelets that secure the outer textured longitudinal edge's surface of the two plus layer to the semi-rigid material. 2) Mechanically applying Rivets/eyelets that secure the “V” shaped semi-rigid material to the outer textured longitudinal edge's surface of the two plus layer. 3) Mechanically applying pressure and optionally spot/ultra sonic/RF welding that secures the “V” shaped semi-rigid material to the outer textured longitudinal edge's surface of the two plus layer. 4) Mechanically sewing either the outer textured surface folder over on itself or to a rigid piece of material. In general, “mechanically fastening” as used herein refers to an interlocking of materials or elements to bind in a secure manner. Specific example of mechanical fastening (and mechanical fasteners) include rivets, eyelets, welding, and sewing.

Prior to describing the invention in detail, the following definitions are set forth to facilitate the understanding of the present invention:

A. Flexible substrate: Any dimensionally stable film such as polyethylene terephthalate (PET), polyethylene naphthalate (PEN), polycarbonate, polyolefins, styrene, nylon, polyether ester ketone (PEEK), polyester sulfone (PES), polyvinyl chloride (PVC), biaxially oriented polypropylene (BOPP); metal foils such as aluminum, copper, nickel, tin, steel, coated steel, stainless steel, brass; paper, both natural and synthetic; and fabric, both woven and non-woven. Substrate thickness may range from about 0.5-20 thousands of an inch depending on desired total thickness. Substrates may be pre-coated with adhesion promoters, anti-statics, ink repellents, and/or a print receptive layer.

B. Textured surface: The non-smooth surface that is on the exposed side of the anti-marking material and which comes in contact with the freshly printed sheet. The textured surface may be embossed with any pattern that provides raised ridges and valleys such that the high points adequately support the freshly printed sheet. Preferred embossed patterns are similar in appearance to the hemispherical portion of the spheroidal element. Alternatively the textured surface maybe formed by partially embedding elements/particles into an adhesive/substrate. Preferred elements are spheroidal partially embedded into the adhesive layer. Alternative textured surfaces include textiles such as woven fabric that has suitable ridges resulting from the warp and fill construction. Other textured surfaces may be created by plasma coating or sand blasting a metal surface followed by plasma/non-stick coatings.

C. Glass/plastic beads: Spheroidal elements of any refractive index having a diameter ranging from about 1 to 100 thousandths of an inch depending on desired end product. Due to their durability and natural ink repellency, spheroidal glass elements are preferred. Alternative spheroidal elements are either plastic or milling beads typically containing Zirconia/zirconium. To obtain the desired textured surface these spheroidal elements are partially embedded into an adhesive layer typically supported by a flexible substrate.

D. Embossed height/partially embedded depth: The protruding height of the textured surface; the height from the apex of the protruding element to the lowest point where the embossed pattern ceases or to where the upper layer of adhesive bonds the spheriodal elements together and onto the flexible substrate. Embedded depth may be varied within a given glass bead diameter by methods well known in the art. These include but are not limited to: varying the thickness/viscosity of the adhesive layer used to initially adhere the glass beads to the flexible substrate; or by later applying a prime or tycot coating that fills in the spaces between the glass beads to control the percent of the glass bead exposed/embedded. Partially embedded depth is typically a ratio of bead diameter which ranges from about 0.05D to 0.6D (D is diameter of bead/embossed pattern) depending on desired end use application. For the diameter glass beads typically used, embedded bead depth ranges from about 0.1 mils to 4 mils. For larger glass beads the embedded depth will correspondingly increase to about 20 mils.

E. Microcellular layer: A layer that is made up of one or more materials containing minute gaseous areas that allow the layer to compress when placed under pressure/weight and provide the layer resiliency upon release of this pressure/weight.

F. Foam: A preferred microcellular layer that can be based on polymers and crosslinked polymers ranging from urethanes, polyvinylchloride nitrites, polyolefins, hypolons, to silicones or the like. Commercially extruded foams are available from Voltek Inc. (Lawrence, Mass.), Sentenial (Hyannis, Mass.), and Rogers Corp. (Rogers, Conn.).

G. Foam-like: An alternative microcellular layer that possesses the unique qualities that allow it to act like a foam with its compressibility and resiliency. Typically, these materials are elastic polymer-saturated paper/fabric. These substrates contain small gaseous areas that allow for a degree of compressibility and resiliency even when saturated or coated with a resin. A preferred Rubber-saturated paper is available from Sunshine Paper Co. (Aurora, Colo.). A preferred Rubber/urethane saturated fabric is available form Cooley, Inc. (Pawtucket, R.I.).

H. Adhesives: Polymers used to either emboss the textured pattern or to embed and bond the elements used for the textured surface. The same polymers may be used to laminate the substrates together. Pressure sensitive adhesives (PSA), thermoplastic and thermoset resins such as phenolics, polycarbonates, polyesters, epoxys, urethanes, acrylics, nylons and polyolefins or suitable alternatives.

I. Ink repellent coatings: An optional coating that may be applied to the textured surface of the anti-marking sheet. These coatings improve the performance of the anti-marking material by repelling printing inks, increasing product life, and allowing for easier surface cleanup at the end of a printing run. Preferable ink repellent coatings are crosslinked resins of silicone (platinum addition cure, tin moisture cure, rhodium cationic radiation cure, free radical cure), fluorocarbon, Teflon, PTFE, silicone/urethane adducts, silicone/epoxy adducts, nylon, fatty acid, or carbomate.

J. Anti-static or conductive coatings: An optional coating that may be applied to both the textured surface and the rear substrate of the anti-marking sheet. These coatings serve to make the surfaces of the anti-marking material conductive thereby preventing electrical charge buildup. Anti-static coatings contain elements such as salts, graphite, etc. Preferred conductive materials include: carbon, aluminum, indium, silver, nickel, copper, tin, and stainless steel. Conductive sheet material may be laminated either between the flexible textured surface and the compressible microcellular material or to the rear of the compressible microcellular material. Conductive materials can easily be vapor deposited onto sheet or web surfaces. Alternatively, conductive materials may be chemically etched onto the surface or simply coated in solution form. Anti-static and conductive coatings may be applied before/during or after the ink repellent coating.

K. Anti-marking cover: A cover that is applied to the outer portion of a press cylinder that reduces the smearing or marking of a freshly printed wet ink sheet/web as it travels through the printing machine. The outer layer consists of a textured surface, and preferably has an ink repellent coating thereon. An optional inner surface such as a microcellular layer is preferred, but not required.

L. Transfer cylinder: Cylinders within a printing machine that facilitate the transfer or transport of a freshly printed sheet from one station to the next. Transfer cylinders are commonly referred to as delivery cylinders, transfer drums, delivery wheels, skeleton/tracking/guide wheels, transfer rollers, delivery rollers and any other movable apparatus that is capable of transferring a freshly printing substrate in a printing press.

M. Magnetic materials: A material used to mechanically affix a covering to a press cylinder. Prior art uses flexible strip magnetic material (ferrite bonded or neodymium-iron boron bonded) that comes in sheet and roll form in varying thickness' but limited magnetic strength, typically 6-18 lbs/linear foot for ¾″ wide. The benefits are that it can be easily laminated to the rear surface of the anti-marking sheet using pressure sensitive adhesive. Preferred magnetic materials are much stronger than strip magnets. Examples of the preferred magnets are alnico and preferably rare earth magnets. Rare Earth magnets can provide two to ten times the strength of flexible magnets. When using a stronger magnet, it is advisable to secure these magnets using some mechanical method and not to rely on adhesive alone.

N. PSA materials: A pressure sensitive adhesive material used to attach a covering to a press cylinder and/or alternatively laminate the layers that make up the longitudinal edges of the anti-marking material together. Pressure sensitive adhesives can be applied in thickness ranging from about 0.5-4 thousandths of an inch and are typically polymers ranging from: urethane, acrylic, rubber, to silicone.

O. Velcro®. materials: A material used to mechanically affix a covering to a press cylinder. This material is made out of two layers, one that has a barbed-like protrusion, the other is the mate to it—a dense layer of loose fibers that mechanically entangle/affix to the barbed protuberances (these layers are sometimes referred to as hook and loop fasteners). It is preferable to place the dense layer of loose fiber-like material on the backside of the anti-marking sheet, and the barbed layer on the press cylinder, or the longitudinal edge of the reusable mechanical fixture. New styles of Velcro®. materials allow for far more secure fastening than in the past, and are specifically designed toward fewer removal cycles and more permanent fixturing. Examples are the Velcro® brand molded hook #8 (MVA #8), Ultra-Mate® Brand HTH fasteners (HTH 15, 22, 24, 29, RF weldable hook fastener), VEL-LOC® Brand quadralobal hook (P93 ad P87). All of these newer styles allow the Velcro® tape to be secured via mechanical means (rivet, eyelet, sew, RF welding) without performance degradation. Certain Velcro® brands such as Velstick® brand may be purchased on semi-rigid plastic extrusions for easy rivet mounting.

P. Nonwoven/woven fabric: A substrate that can be used as the flexible layer or textured surface in the anti-marking material. Commonly used materials include: nylon, polyester, polyolefin, cotton, rayon, acrylic or combinations thereof. It is preferred to use fabrics that have been scoured and heat-set for stability. They may be further processed or saturated with an elastic resin or ink repellency. A new fabric called Evolon® (a microfilament fabric available from Freudenberg Evolon of Colmar, France) possesses a unique textured surface that when coated with an ink repellency exhibits very good anti-marking characteristics and may be used in lieu of the Super Blue® net, or as the textured surface on a covering.

Q. Printing press: Printing presses tend to be categorized as sheet feed presses such as offset printing or web fed machines such as flexographic. Anti-marking sheets are predominately used in offset printing as the substrate cannot be held under constant tension as it moves from one printing station to the next. Anti-marking tape that is spiral wound around support/press cylinders is typically used on web machines.

R. Stretchable/elastic Loop: The material affixed to the longitudinal edge of a covering. The elastic loop may be made out of any stretchable material such as rubber, epdm, coated fabric, urethane, silicone etc. The preferred materials are urethane and silicone due to their resistance to solvents and oils. The degree of elasticity (elongation) should be selected according to desired fit on the press. Likewise the thickness of the elastic loop should be selected to ensure proper fit within the transfer cylinders edge and tolerances upon rotation.

S. SM-102 Rivet: The dome-like rivet hardware affixed to the longitudinal edge of an anti-marking sheet that fits on the newer Heidelberg Speedmaster 102 transfer cylinder. There are ten rivets that fasten through the sheet after being wrapped around a steel strip. This end of the jacket fits easily into a spring bar that is already affixed to the Heidelberg transfer cylinder. The other end of the jacket can either have a stainless steel strip or an elastic/non-elastic die cut loop which fits securely on the other side of the transfer cylinder.

T. Reusable SM-102 Rivet Bar: A reusable hardware affixed to the longitudinal edge of an anti-marking sheet that fits on the newer Heidelberg Speedmaster 102 transfer cylinder. Preferably, the mechanical fastening method uses the newer Velcro® super strong hook style (MVA#8 9972 and see options listed under Velcro® definition) which is affixed (sewn onto a piece of fabric) or directly affixed to the bar that will hold the 10 rivets. After affixing the Hook Velcro to the bar, the 10 custom rivets are securely fastened in designated holes in the metal bar. This now becomes a reusable piece, the 10 SM102 rivets fit easily into a spring bar that is already affixed to the Heidelberg transfer cylinder. The end of the jacket that used to have the expensive non-reusable 10 SM102 rivet bar now only requires a strip of loop Velcro® affixed by adhesive and or sewn onto that edge, reducing both labor and cost of manufacturing this jacket. Other mechanical mating fixtures may be used in substitution of the Velcro® hook and loop method herein described to achieve the same results.

U. Compressible packing: Packing is an industry term that refers to the product used to pack or fill the gap that is desired between two cylinders on a printing press. This is typically part of the make-ready process where the pressman decides what thickness packing is required to run a desired paper weight. Packing can range from just a few mils (thousandths of an inch) to several hundred mils depending on the press and the cylinder. Packing prevalent in the industry today is typically paper, but film and film with PSA backing is also used. The term compressible packing is meant to describe a type of packing that is a hybrid of certain illustrated embodiments of the invention and traditional packing, consisting of a microcellular backing adhered to either a flexible film, paper or fabric. Compressible packing could be used under an anti-marking cover that does not possess a microcellular backing. Alternatively, in some cases the microcellular backed anti-marking jackets may require additional microcellular packing to insure proper gap between cylinders such as in between the impression and blanket/coating cylinder, perfecting cylinders or transfer cylinders. The packing under the plate cylinder may also benefit from this type of compressible, especially with the textured low energy surface. In some cases, the extra expense of using the microcellular backing on the textured surface in lieu of less expensive microcellular backing on a paper or film material is warranted.

V. Press cylinder: Refers to either the general term for either the transfer, impression, perfector (whole or ribbed), blanket/coating, or plate cylinder of a printing press.

W. Rivet/Eylet: Refers to any metal or plastic mechanical fixture that can mechanically affix two separate materials in such a manner that they remain securely fastened together from freezing temperatures to 150 degrees Fahrenheit and imperious to typical press cleaning chemicals.

X. Semi-rigid material: a plastic or metal material, that if necessary, is used to stiffen the edge of an anti-marking cover that fits into the OEM's mechanical fixture designed to securely hold the antimarking cover.

Y. OEM's mechanical fixture: refers to the multitude of fixtures a printing press OEM (Original Equipment Manufacturer) designs for each model press. These vary from the older Heidelberg style of grooved bolt like protrusions that allow a stainless steel rod to be snapped behind, to the newer style of pin/custom slot openings that have various clamping methods.

Z. Reusable SM-74 Pin Bar: A reusable hardware affixed to the longitudinal edge of an anti-marking sheet that fits on the newer Heidelberg Speedmaster 74 transfer cylinder. The newer Velcro® super strong hook style (MVA#8 9972 and see options listed under Velcro® definition) is adhesively and mechanically affixed onto a steel bar that has eight die cut holes. The bar securely fits over the eight pins that stick up on one end of the transfer cylinder. On optional locking piece can be added. This now becomes a reusable piece, the eight die cut holes mechanically fit over the corresponding pins and help to lock into place when the lower strip of metal at the upper end of the die cut locks in place under the lip of the eight pins. The longitudinal edge of the anti-marking cover that used to have the expensive non-reusable bar with eight die cuts now only requires a strip of loop Velcro® affixed by adhesive and mechanically sewn onto the corresponding longitudinal edge of the anti-marking cover, reducing both labor and cost of manufacturing this jacket. Other mechanical mating fixtures may be used in substitution of the Velcro® hook and loop method herein described to achieve the same results.

AA. Form fit: refers to the manner the anti-marking cover fits over the press cylinder. Of great importance is the fit of this cover on any portion of the press cylinder that comes in contact with the wet inked sheet. A good form fit will allow both easy installation of the anti-marking cover such that it will not have any air bubbles, ridges, or creases between the anti-marking cover and the press cylinder. These problems typically occur upon in the transition area from the fixture to the surface of the press cylinder.

AB. Mechanically fastened stiff longitudinal edge: refers to the modified longitudinal edges of the anti-marking cover. Preferably, it consists of a semi-rigid material layer that is optionally adhesively bonded to the backside of the textured surface layer, followed by the mechanical fastening of these layers permanently together. Preferred mechanical fastening uses rivets or eyelets.

AC. Anti-Skid Tape: refers to the material used to build up the thickness of the longitudinal edge of the anti-marking cover and provide improved mechanical gripping during the crimping stage of mechanically fastening the bar to this edge. There are several manufacturers of Anti-Skid Tape, 3M, Brady Corporation. The Anti-Skid tape contains an abrasive grit adhesively mounted to a flexible substrate, typically with a pressure sensitive back coating.

The examples and embodiments depicted in the drawings and described herein include anti-marking covers of the invention preferably having a minimum of two layers: a textured surface outer layer and a microcellular inner layer. These embodiments are for use on high speed printing equipment, for example on offset printing machines. This equipment typically uses transfer cylinders and/or skeleton/tracking wheels for handling freshly wet printed sheets between printing stages and upon delivery of the printed sheet to the discharge stack. Those skilled in the art will readily understand both the benefits and flexible alternatives for mounting this new textured surface anti-marking sheet with a microcellular layer to any cylinder on printing machines, many of which are described herein.

Other and further objects and advantages of the present invention will become apparent from the following description of preferred, but not necessarily the only, forms of the present invention, taken in connection with the accompanying drawings.

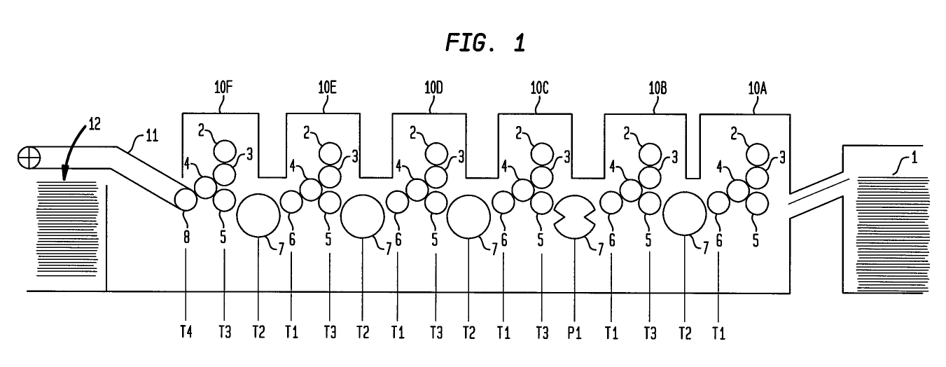

The improved method and apparatus for supporting freshly printed sheet material in accordance with the present invention is typically used in high speed printing presses, most often in offset printing. A brief summary of the printing process follows by reference to FIG. 1. A sheet is feed into the printing press from the sheet feeder 1, and travels through the first color printing station 10A to be printed with the first color as the sheet is pressed between the blanket cylinder 3 and impression cylinder 4. This freshly wet printed sheet now must travel from the first printing station 10a to the second color printing station 10b. In order to accomplish this, the sheet is supported and transported with its wet ink side down over the first transfer cylinder 6 (T1). Next the sheet is transferred with its wet ink side up onto and over the intermediate transfer cylinder 7 (T2), and then over to the third transfer cylinder 5 (T3) with its wet ink side down, and then back up to receive the second color as the sheet is pressed in between the blanket cylinder 3 and the impression cylinder 4 in printing station 10b. This process is repeated each time as the sheet travels from one color station to the next until reaching the last station where the sheet travels again with its wet ink side down over the delivery cylinder 8 (T4) and on through the conveyer system 11 and onto the sheet stacker 12.

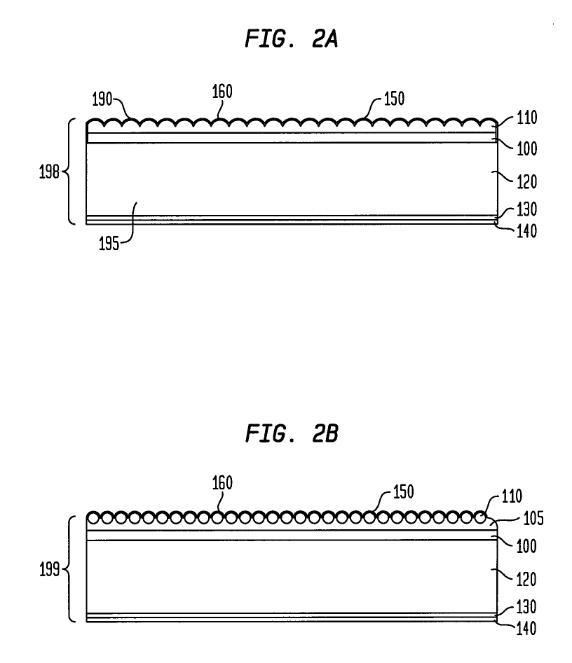

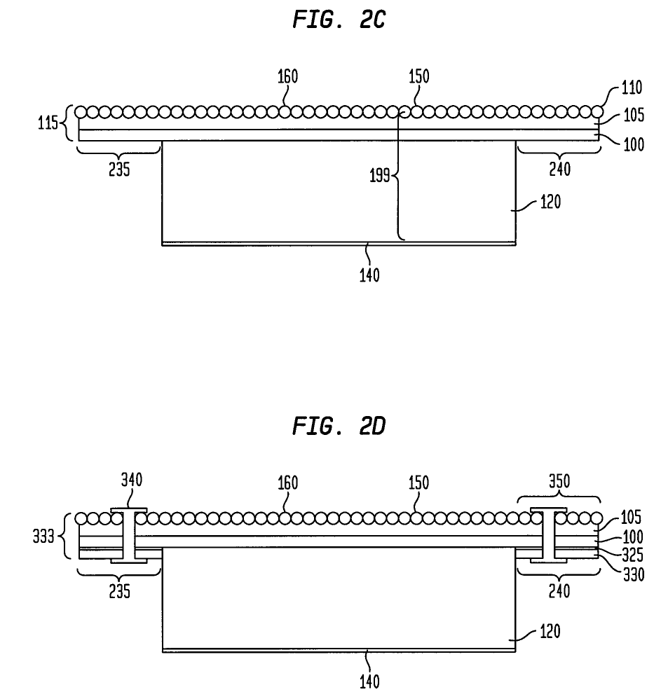

From the above description, one can readily understand that marking or smearing of the wet printed sheet occurs when sheet is being supported and transported with its wet ink side down over the transfer cylinders T1 and T3 on its way to the next printing station. The present invention can provide an anti-marking cover having at least two layers that is easily applied to the outer surface of these transfer rolls, and as required on other press cylinders. The layers comprise at a minimum an outer and inner layer with optional layers/coatings as portrayed in FIG. 2a and FIG. 2b. The outer layer is a durable textured surface 110 that provides a raised pattern that supports the wet ink side of the sheet being printed, and prevents the marking or smearing of the wet ink on the sheet during transfer. The inner layer is a microcellular layer 120 that allows for uniform application and support of the outer layer onto the cylinder. The microcellular layer 120 is compressible and resilient allowing for easy level installation and uniform packing. The microcellular layer further improves durability of the outer textured layer by allowing distinct areas to compress when required (creased/folded paper sheet) and then resiliently returning to its former position.

FIG. 1 depicts a 6 color press, with a perfecting station after the second color station 10B. The perfector flips the sheet over so that from station 10C through the delivery ink is printed on the reverse side from that printed during station 10A and 10B. A perfector enables a press to print both sides of the paper in one pass. This saves on production time and costs, but at an increased cost of marking if the press cylinders post the perfector station are not fitted with anti-marking covers.

Anti-marking coverings useful with the present invention are sometimes referred to as a “two plus layer” system meaning that there are two layers along with optional coatings or layers that can be added to improve the characteristics or installation of the covering. The two layers are: the outer layer 190 consisting of a minimum of the textured surface 110 and the inner layer 195 consisting of a minimum of the microcellular layer 120. Referring to the exemplary construction of FIG. 2a, the textured surface 110 can be embossed in the pattern of hemispherical spheroids, or half spheres adhered to an optional flexible substrate 100. This pattern, though preferred, is not depicted to limit the various embossing patterns that are suitable and fall within the scope of the present invention. An optional vapor deposited aluminum conductive coating 150 can be applied onto the exposed surface of the embossed pattern 110. Upon this conductive coating an optional ink repellent coating 160 can be applied. The outer layer can then be flipped upside down and a laminating adhesive can be coated onto the underside of the flexible substrate 100 whereupon a microcellular layer 120 can be laminated. Next an optional anti-static conductive coating 140 can be applied to a flexible substrate 130 and then laminated to the underside of the microcellular layer 120. This example is for illustration only and a person of ordinary skill in the art will readily understand the various raw materials and processes that can be alternatively used to obtain similar desired results.

Numerous methods exist for the construction of a textured surface for an anti-marking sheet. One skilled in the art of manufacturing either sand paper or reflective sheeting will readily understand how to partially embed glass beads onto a substrate. In U.S. Pat. No. 2,555,319 for example, Cross fully discloses the steps for manufacturing this textured surface to include prime coating the surface of the glass beads for better adhesion and also ink repellency. Such techniques can be used to manufacture the textured surface of the anti-marking sheet depicted in FIG. 2b. In this embodiment, the textured surface is constructed from glass beads 110 that are partially embedded into the flexible adhesive 105 supported by the flexible substrate 100. The desired end product use (type of printing press coupled with the type of sheets printed) determines both the proper selection of glass bead diameter as well as the thickness of adhesive 105 required to properly secure and embed the glass beads. Next, an anti-static material 150 can be coated upon the surface of the exposed glass beads followed by an ink repellent coating 160. This coating also falls in the valleys between the spaces of the glass beads aiding in the prevention of ink buildup and vastly improves the cleanliness of the textured surface. This outer layer can then be flipped upside down and a laminating adhesive coated onto the flexible substrate 100 where upon a microcellular layer 120 can then be laminated. Next an anti-static conductive coating 140 can be applied to a flexible substrate 130 and laminated to the underside of the microcellular layer 120. Again, this example is for illustration only, one skilled in the art will readily understand the various raw materials and processes that can be alternatively used to obtain similar desired results.

The anti-marking sheet can have a longitudinal edge that is modified so that it may be easily mounted to any manufacturers press cylinder's fastening device. Typically, the first step in this modification is shown in FIG. 2c, where the microcellular layer 120 is carefully removed only along the longitudinal edge 235 (and in this figure also along the second longitudinal edge 240)—typically less than one inch wide along the entire longitudinal edge. There are many methods for providing that a two plus layer 199 be present along the entire cover, except along the longitudinal edges where the mechanical fixtures are provided. One skilled in the art will know there are various manufacturing steps such as buffing (sanding down the undesired layer), skiving (removing the undesired layer with a sharp blade), applying a release layer along longitudinal edge prior to coating the entire surface with the microcellular layer, and other means not listed. Depending upon the manufacturing process, it may also be possible to apply the microcellular layer only to the desired portions so that a portion of it need not be removed. FIG. 2c depicts a covering where the main area (center) consists of the two plus layer 199, and along the longitudinal edges there is no microcellular layer 120, just the textured surface 110 bonded to the flexible substrate 100 with adhesive 105. This textured layer 115 is much thinner than the two plus layer and can now allow the mechanical fastening of a thin semi-rigid layer to it such that it mimic's a steel edge that securely fits into the OEM mechanical fixture.

FIG. 2d. depicts an anti-marking cover's longitudinal edge in one embodiment of the invention. This particular design works well on the SM-52 Heidelberg Press. The longitudinal edges 235 and 240 from FIG. 2c are reinforced with a semi-rigid layer 330 with an optional adhesive 325 to form a stiff longitudinal edge 333. Next this stiff longitudinal edge 333 is mechanically fastened together using a rivet or eyelet 340 to form a mechanically fastened stiff longitudinal edge 350 of the anti-marking cover. The total thickness of the mechanically fastened stiff longitudinal edge typically does not exceed 150 thousandths of an inch, and frequently the rivet/eyelet needs to be flattened on both sides to minimize the total thickness.

In one embodiment, the mechanical fastener is an eyelet that is flattened on both sides. In such an embodiment, it can be helpful if the fastener is formed of a malleable material, such as, for example, brass. In still further embodiments, the dimensions of the eyelet can be arranged to give optimal results. In one such embodiment, the flange (or overall diameter) of the eyelet can be greater than or equal to about 1.5 times the barrel diameter of the eyelet. In such an embodiment, the stiffening strip is suitably fastened to the anti-marking cover while guarding against pull-out of the eyelets from the flexible substrate under stress. In a further preferred embodiment, the flange diameter of the eyelet is greater than or equal to about 3.0 times the barrel diameter of the eyelet.

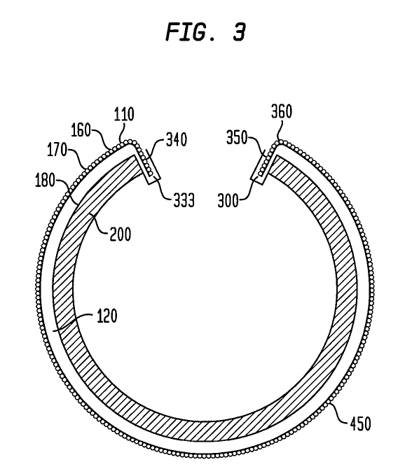

FIG. 3 depicts a covering as mounted onto a generally C-shaped transfer cylinder 200 having inner surfaces for the fixturing of an anti-marking covering. Depending on the press and the thickness of the sheet paper being run, the press operator may decide to include packing 180. The packing 180 may be secured in place by the anti-marking cover's microcellular layer or by the use of a pressure sensitive adhesive. Alternatively, the anti-marking sheet may be secured to the transfer cylinder along the length of the cylinder with pressure sensitive double-sided tape. Here, the textured surface 110 can be coated simultaneously with an ink repellent and an anti-static coating 170. The mechanically fastened stiff longitudinal edge 350 of the anti-marking cover 450, fits securely into the OEM's mechanical fixture 300, located on the lead and tail longitudinal edges of the press cylinder. The mechanical fastener 340 prevents the layers of the stiff longitudinal edge 333 from separating under adverse environmental conditions. The mechanically fastened stiff longitudinal edge seats low enough in the OEM's fixture so that the anti-marking cover provides a form fit 360 around the critical turn from the fixture to the surface of the press cylinder. The microcellular layer 120 allows the operator to easily install the outer textured layer so that is lays perfectly flat (a good form fit) against the cylinder surface thereby preventing bubbles, ridges or creases that typically occur when applying anti-marking sheets to transfer cylinders. An anti-static coating 180 can be applied to the exposed surface of the microcellular layer 120 prior to mounting it to surface of the transfer cylinder.

In a still further embodiment, a two plus layer anti-marking covering is adhesively affixed to a press cylinder by uniformly applying a pressure sensitive adhesive to the backside of the microcellular layer, followed by a thin flexible synthetic release liner. Prior to this invention, the manufacturability of applying a pressure sensitive adhesive was impossible because after the adhesive was applied, the release liner was nipped onto the adhesive and as this sandwich layered product was wound up, it would buckle, much the way cardboard does when one attempts to wind it or bend it over a small radius.

The theory behind making a pressure sensitive backing to the two plus layer is simple, the execution was, up till the present invention, technically impossible. The problem occurs when you sandwich a soft compressible (microcellular) layer between two stiffer substrates. This is what happened in the past: the textured surface is fairly hard, the microcellular layer is soft and compressible, so in the past when a pressure sensitive adhesive was laminated to the rear of the microcellular layer followed by the nipping of the paper release liner, instead of bending or rolling, it would buckle or break the liner creating permanent damage to the microcellular layer. The effect was like bending cardboard, once broken, it lost its original properties and could not be used for its intended purpose.

Embodiments of the present invention were developed using an understanding of the cause of failure, and testing suitable substrates that were also feasible as release liners. A release liner is typically coated with a silicone polymer. The silicone coated side of the liner is non stick, so it can be used to temporarily cover the pressure sensitive adhesive, and be removed by the pressman at the time of installation, thereby exposing the pressure sensitive adhesive which is applied directly to the press cylinder. Embodiments of the invention can use a synthetic release liner such as polypropelene, or even a very thin polyester or low density polyethelene which are softer and more flexible than stiffer release liners such as paper. Using this flexible release liner removes the problem of having a firm-soft-firm sandwich, and now creates a firm-soft-flexible sandwich that can be manufactured and even later shipped in a tube without buckling.

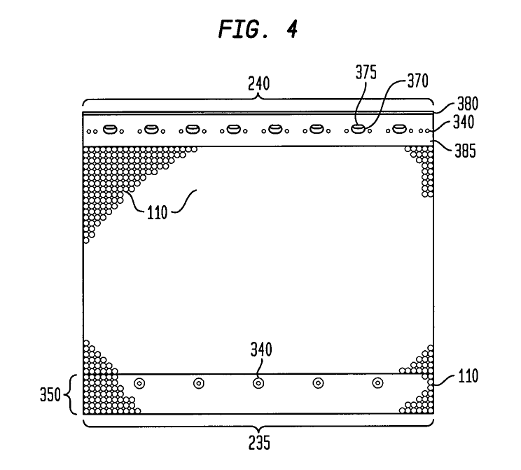

FIG. 4 depicts a covering configured for the Heidelberg SM-74 press. This press requires two different mechanical fixtures along each longitudinal edge 235/240 of the anti-marking cover. The first longitudinal edge 235 uses the same mechanical fastener as depicted in FIGS. 2d to form a fastened edge 350. This mechanically fastened stiff longitudinal edge 350 slides into the OEM mechanical slot fixture along the gripper side of the cylinder. The pressman closes the slot using a 13 mm wrench which pivots the cam with a rubber raised edge to securely lock in against the stiff longitudinal edge 333. The stiff longitudinal edge is manufactured in the same manner described above in FIG. 2d. Next the pressman rotates the cylinder while holding onto the other end of the longitudinal edge 240, until the other OEM fixture comes into position. The OEM fixture on one side of the cylinder has eight pins that extend out of a support bar on one side of the transfer cylinder. The longitudinal edge 240 fits over and locks under these eight pins. This support bar is then extended by rotating a single hex (newer models use allen) bolt by the pressman, thereby tensioning and locking the jacket securely to the transfer cylinder.

Included herein are at least two designs for this anti-marking cover. One embodiment using the two plus layer; and another embodiment using the same mechanical fixtures on each longitudinal edge, but omitting the step of the microcellular backing for cost reasons, and an optional a packing sheet, (preferably a microcellular packing sheet) is placed under the textured surface during installation of the anti-marking cover onto the transfer cylinder. This latter method is much easier to fabricate (since removing the foam along the longitudinal edges is not required) and less costly. The microcellular packing could be reused, making the cost of the packing minimal. This method, though less costly to manufacture, is more difficult to install on press, and as such may not allow for a true form fit in the same manner as other embodiments.

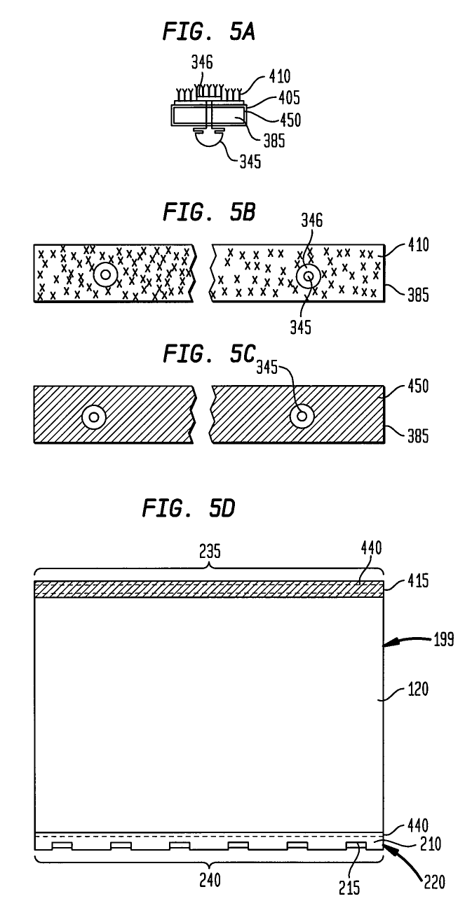

FIG. 5 depicts a covering configured for a Heidleberg Printing press for the newer model SM102. According to this embodiment, the two plus layer anti-marking cover is modified by affixing at least one elastic loop 210 to the longitudinal edge 240 of the anti-marking cover and one reusable SM-102 Rivet Bar to the other longitudinal edge 235 of the anti-marking cover. Alternatively, a mechanically fastened stiff longitudinal edge may be substituted for the elastic loop side.

FIG. 5d depicts an SM102 Heidelberg transfer cylinder anti-marking cover with one longitudinal edge containing Velcro® loop to receive the reusable SM-102 Rivet Bar and the other edge with an elastic loop jacket thereon mounted. The particular printing press model (and transfer cylinder size) determines the placement of the die cut areas 215 along the longitudinal axis of the elastic loop 210, as well as the mechanical fixture on the other longitudinal edge.

A Reusable SM-102 Rivet Bar (FIG. 5b, 5c) is one that can be easily reused by the pressman; this requires the upfront design of both the anti-marking cover and fixture system that readily fits into the SM-102 OEM fixtures and securely affixes the jacket to the cylinder. FIG. 5a is a cross sectional view of FIG. 5b and FIG. 5c, the reusable SM-102 Pin Bar. FIG. 5a shows the use of one piece of sheet metal 385 with a folded over optional fabric 450 therein sewn Velcro® Hook 410 that is both adhesively 405 and mechanically fastened with an eyelet 340 to the steel hardware 385, in a specified location that corresponds to the OEM ten tear drop die cuts in the spring bar.

FIG. 5d depicts an anti-marking cover with the mating Velcro® loop 415 mechanically fixed 440 to one longitudinal edge 240 with the above mentioned mechanically fastened stiff longitudinal edge 350 attached to the other longitudinal edge 235. The operator can assemble the two mating Velcro® longitudinal edges together either on or off the press.

In one embodiment, the pressman assembles the reusable SM-102 Rivet Bar to the mating Velcro® loop longitudinal edge of the anti-marking cover shown in FIG. 5d. Now the anti-marking cover can be easily installed. The pressman snaps the reusable SM-102 Rivet Bar containing the ten custom rivets into the mating OEM mechanical spring bar fixture on the Heidelberg SM102 transfer cylinder. Next the pressman rotates the cylinder until the elastic loop longitudinal edge FIG. 5d (alternatively the mechanically fastened stiff longitudinal edge) aligns with the OEM mechanical six grooved bolt fixture at the other side of the cylinder (alternatively the OEM clamping slot). The pressman snaps the stainless steel rod 220 held by the loops behind their corresponding OEM fixtures. Next the pressman tightens the anti-marking cover by applying downward pressure on the flip up portion of the transfer cylinder so that in the closed position it tensions the anti-marking cover. The cylinder flip up lip is then locked down into the closed position. The pressman next inspects the anti-marking cylinder cover for proper form fit all the way around the cylinder.

When this anti-marking cover wears out, the pressman removes (and discards) the worn part (FIG. 5d), and keeps the reusable SM-102 Rivet Bar (FIG. 5a-c) for use time and time again. The pressman re-orders the replacement part (FIG. 5d) and again affixes the reusable SM-102 Rivet Bar to form a single component anti-marking cover that is easily installed. It is understood that there are other means for constructing a reusable mechanical fastening. In this embodiment of a two part anti-marking cover, one longitudinal edge contains the mechanical fixture that fits directly into one end of the press cylinder; and the second longitudinal edge contains the mechanical fixture that fits directly into the second end of the press cylinder, and the two parts mate back together along with the central portion of the anti-marking cover to form one anti-marking cover.

In this embodiment, the microcellular layer 120 is under slight constant compression thus ensuring the most uniform fit at every point along the cylinder 200 such that the outer textured surface is perfectly aligned with the surface of the freshly printed wet inked sheet. This preferential alignment coupled with the technological surface texture 110, two plus layer structure, and optional coatings 170 make for a mark free transfer of the wet inked sheet from one station to the next.

The newer Heidelberg SM-74 press requires a fixture that fits over eight pins that extend out of a support bar on one side of the transfer cylinder. This support bar is then extended by rotating a single bolt by the pressman, thereby tensioning the jacket. There are two types of fixtures that can be used for this press, a permanent fixture and a re-useable fixture. A permanent fixture (FIG. 4) is one that cannot be easily re-used by the pressman; i.e. it is permanently affixed to the anti-marking cover either by riveting, sewing or adhesive. The anti-marking cover is a single piece with both longitudinal edges having a permanent fixture that fits into the OEM fixture.

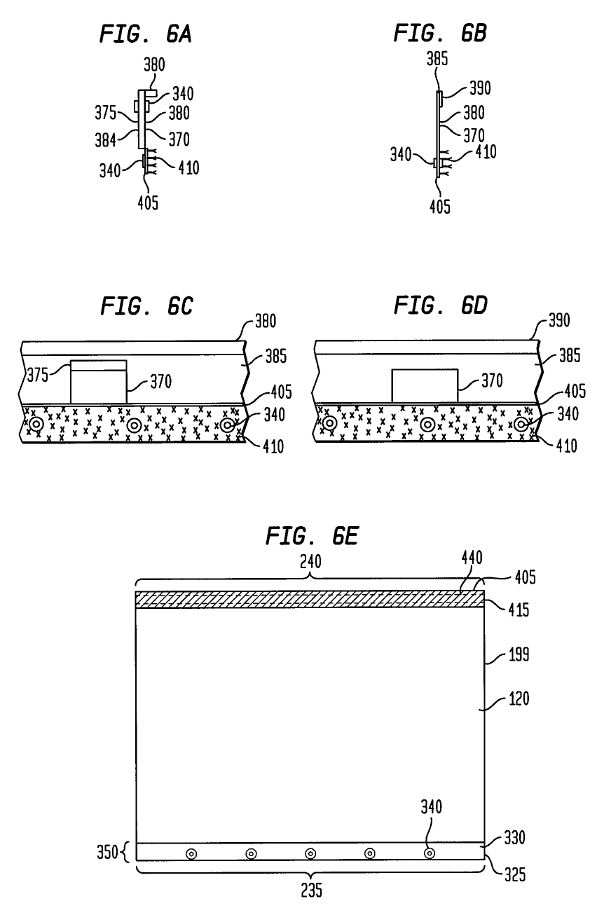

A reusable SM-74 Pin Bar fixture (illustrated in FIGS. 6a, 6b, 6c, and 6d) is one that can be easily re-used by the pressman; this requires the upfront design of both the anti-marking cover and fixture system that readily fits over the SM-74 pins and securely affixes the jacket to the cylinder. FIG. 6a (a cross sectional view of the reusable SM-74 Pin Bar of FIG. 6c) shows the use of two pieces of sheet metal (384, 385) mechanically fastened together with eyelets 340. Velcro® Hook 410 is both adhesively 405 and mechanically fastened with an eyelet 340 to the steel hardware 385. Both upper 370 and lower 375 die cut areas line up to provide a lower lip edge 375 which hooks under the lip of the OEM pin (one of eight). The upper ninety degree bend 385 adds structural stability during and after mounting the anti-marking cover to the transfer cylinder. In an alternative embodiment, FIG. 6b is a cross sectional view of FIG. 6d, the reusable SM-74 Pin Bar. FIG. 6b shows the use of one piece of sheet metal 385 with a folded over and flattened top edge 390 for structural purposes. Velcro®Hook 410 is both adhesively 405 and mechanically fastened with an eyelet 340 to the steel hardware 385, typically just below the die cut area 370. The single piece of die cut hardware 385 is thin enough to fit under the lip of the OEM pin (one of eight). Advantages of this one piece design include simplicity and low cost.

FIG. 6e depicts an anti-marking cover with the mating Velcro® loop 415 mechanically fixed 440 to one longitudinal edge 240 with the above mentioned mechanically fastened stiff longitudinal edge 350 attached to the other longitudinal edge 235. The operator can assemble the two mating Velcro® longitudinal edges together either on or off the press. Optionally, one may install a lock device to prevent the reusable die cut piece of material with Velcro® hook from ever moving off the 8 circular pins.

In one embodiment, the pressman assembles the reusable SM-74 Pin Bar to the mating Velcro® loop longitudinal edge of the anti-marking cover shown in FIG. 6e off the press. Now the anti-marking cover can be easily installed. The pressman slides the mechanically fastened stiff longitudinal edge 350 into the mating OEM mechanical clamping fixture on the Heidelberg SM74 transfer cylinder. Next the pressman rotates the cylinder until the reusable SM-74 Velcro® Pin Bar hardware FIG. 6a/c or, 6b/d with Velcro® hook 410 already attached to the anti-marking cover (FIG. 6e) aligns with the OEM mechanical eight pin fixture at the other side of the cylinder. The pressman snaps the eight die cut areas 370 over the OEM's eight circular pins, so that the lower lip edge 375 of the die cut material fits securely under the lips of the circular pins. Next the pressman tensions the jacket until form fit to the cylinder. The pressman next inspects the anti-marking cylinder cover for proper form fit all the way around the cylinder.

When this anti-marking cover wears out, the pressman removes (and discards) the worn part (FIG. 6e), and keeps the reusable SM-74 Pin Bar (FIG. 6c or FIG. 6d) for use time and time again. The pressman re-orders the replacement part (FIG. 6e) and again affixes the reusable SM-74 Pin Bar to form a single component anti-marking cover that is easily installed.

It should be understood that there can be other means for constructing a reusable mechanical fastening. The illustrated embodiment shows a two part anti-marking cover where one longitudinal edge contains the mechanical fixture that fits directly into one end of the press cylinder along with the main body of the anti-marking cover which is disposable, and the second longitudinal edge contains the reusable mechanical fixture that fits directly into the second end of the press cylinder along with a mating mechanical fixture that readily attaches to the main part of the anti-marking cover that is part of the first longitudinal edge. These two parts mate back together to form one anti-marking cover.

A person of ordinary skill in the art will recognize that in further embodiments of the present invention, the anti-marking sheet of the invention having at least two layers could be alternatively used for multiple other cylinder coverings besides transfer cylinders. In one embodiment the two plus layer sheet was mounted on a plate cylinder with the plate mounted thereon. In another embodiment, the two plus layer sheet was mounted on both the delivery, blanket/coater, perfector and impression cylinders. In each cylinder case, an outer textured layer coupled with a preferred inner microcellular layer proved a suitable combination for improving the quality of print on the sheet. Alternatively, if the plate, delivery, blanket/coater, perfector or impression cylinder outer diameter requires an anti-marking cover without packing or without a microcellular backing, it is understood that the same attachment methods are feasible, alternatively, if additional packing may be required to ensure proper outer diameter gap is maintained with respect to adjacent cylinders.

Mechanical fixtures are required in particular for fastening the longitudinal edges of the anti-marking cover to the impression cylinder. The mechanically fastened stiff longitudinal edge is preferably secured using eyelets. The impression cylinder anti-marking cover requires a semi-rigid material, that when mechanically fixed, will provide easy and secure installation of the cover. Any of the methods earlier discussed, or later in the preferred embodiment may be used to provide semi-rigidity such that the longitudinal edges of the anti-marking cover will attach securely into the OEM's fixture.

For the perfecting cylinder, the preferred mechanical fixtures are strong magnets that are mechanically fastened to the edges of the anti-marking cover. The thickness of the anti-marking cover will be determined by the press model and the thickness of the sheet paper run, and if necessary, the microcellular layer may be omitted due to outer diameter gap constraints. Preferred embodiments secure the magnets to the anti-marking cover's longitudinal edge using eyelets or rivets, typically with a semi-rigid material in between the textured anti-marking cover and the magnet. Velcro may be used, but it must be mechanically fastened to both the rear of the magnet and to the longitudinal edges of the anti-marking cover.

In another embodiment of the present invention, magnets are mechanically fixed to the edges of the anti-marking cover. This product is particularly well suited for rapid attachment to the perfector cylinder (ribbed on Heidelberg presses) of a printing press. The magnets are mechanically fixed to allow for the use of a stronger magnet that will not detach from the cylinder during high speed printing. To prevent the textured surface from tearing, an optional rigid material is both adhesively and mechanically affixed and preferably sandwiched between the magnet and anti-marking cover.

In another embodiment of the present invention, Velcro® is mechanically sewn to the edges of the anti-marking cover. This product is particularly well suited for rapid attachment to the perfecting cylinder (ribbed) of a printing press. The Velcro® is mechanically fixed to the cylinder. To prevent the textured surface from tearing, an optional rigid material is both adhesively and mechanically sewn and preferably sandwiched between the Velcro® Hook and anti-marking cover.

A method of securely fixing a glass beaded material to the Blanket/coating cylinder whereby the textured surface uniformly supports a freshly printed sheet material as the freshly printed sheet material is conveyed between a blanket/coating cylinder and the impression cylinder, the two part layer comprising an inner flexible microcellular material that is resilient to compressive forces provided on the outer face of the blanket/coater cylinder; and an outer flexible substrate layer provided on the flexible microcellular material and having a textured surface protruding from a first side in a direction away from the flexible microcellular material for supporting the freshly printed sheet material. A rigid strip material that is extruded, or mechanically bent in approximately half along the long axis, the full length of the anti-marking covers longitudinal edge and adhesive is optionally used to temporarily secure semi-rigid “V” or “U” strip to anti-marking cover longitudinal edge while a break is used to crimp the “V” strip securely to the edge. Rivets or Eyelets are optionally used to permanently secure the “V” or “U” strip to the anti-marking cover longitudinal edge. Alternatively, ridges or teeth can be preformed in the “V” to permanently secure the edge.

Typically the total thickness of the mechanical fixture (to include rigid strip of material and anti-marking cylinder cover) does not exceed ¼ inch, and preferable is less than 3/16″ thick. The rigid part of the anti-marking cover's longitudinal edge does not extend above the top surface of the perfector/blanket/coater cylinder in such a way that the flexible portion of the anti-marking cover makes the bend around the upper part of the press cylinder such that an easy form fit along the entire length of the cylinder's longitudinal edge is obtained.

In accordance with another embodiment of the present invention, a method for easily and quickly affixing a loop to at least one longitudinal edge of an antimarking cover uses either an extruded “Z” shaped aluminum bar or a “Z” shaped piece of sheet metal. The two ends that form the loop are fitted into the bottom part of the “Z” and the anti-marking cover's edge is fitted into the top portion of the “Z”; whereby the metal material is compressed, mechanically fusing the loop to the anti-marking cover. In past anti-marking covers designed to fit on the Heidelberg transfer cylinder were formed by looping over on itself and sewing a loop that held the stainless steel rod which fit the mating Heidelberg mechanical fixture. Alternatively, a separate elastic loop was sewn onto the antimarking cover. The stitching of the sewn loops would sometimes tear during installation. The present invention can solve this problem. In accordance with another embodiment of the present invention, a rivet/eyelet mechanical fastener secured the loop ends together. The same type of fixturing method used for the perfecting/blanket/coating cylinder anti-marking covers can be applied for this fixture with the modification of the fixture looking more like a “Z” than a “V” or “U” cross sectional profile.

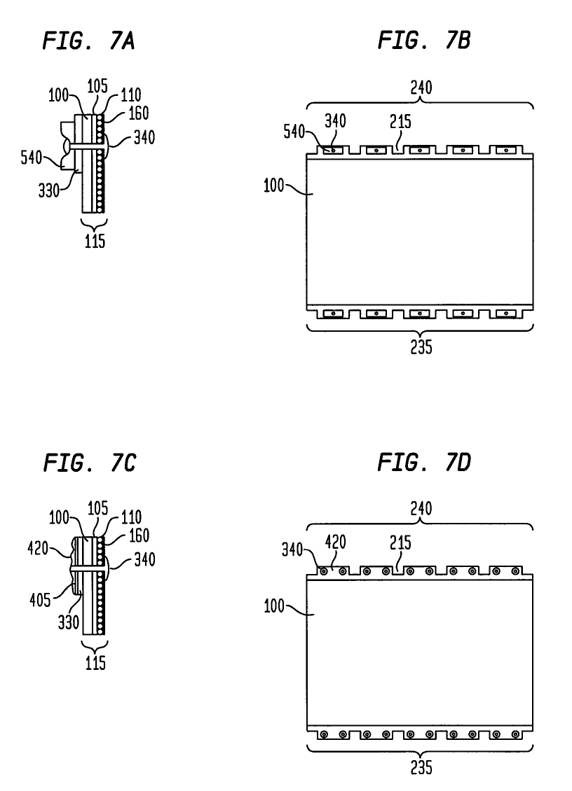

FIG. 7 depicts, in another embodiment, a mechanical means fastening the backside of the longitudinal edge of the anti-marking sheet so that it may be easily mounted and removed from a perfector cylinder. This anti-marking cover is mounted on the perfector (whole or ribbed) cylinder. This anti-marking cover facilitates the transfer of the double sided freshly inked sheet from one station to the next without marking.

FIG. 7b depicts an anti-marking cover that is designed to be affixed to a perfector or ribbed cylinder of printing press. The operator affixes the first longitudinal edge 235 of the anti-marking cover of this embodiment to perfector or ribbed cylinder by affixing the strong magnets to the cleaned inside lip of the ribbed cylinder. Once firmly secured, the operator will slowly rotate the cylinder, all the while applying constant tension from the second longitudinal edge 240 in such a manner that the anti-marking sheet is applied uniformly and lays flat against the surface of the cylinder. Upon completion of the cylinder's rotation, the second longitudinal edge 240 is secured to the cleaned inside longitudinal edge of the cylinder.

FIG. 7a is a cross sectional view of the mechanically adhered magnetic fixture that is affixed to the longitudinal edge of the anti-marking cover for a perfector cylinder. The magnet 540 is optionally adhesively adhered to a metal strip 330 which is die cut 215 along with the longitudinal edge 240 of the anti-marking cover in such a manner as to not conflict with the cylindrical bolts (pincer bars) of the perfector cylinder. The die cut rigid metal strip 330 is optionally adhesively adhered to the antimarking cover 115. The magnets 540 are mechanically fastened to the metal strip 330 using eyelets 340 or suitable mechanical fixtures.

FIG. 7b is a diagram of the magnetic anti-marking cover, the textured surface is on the rear side of the diagram as shown. The textured surface 110 is preferably coated with an ink repellent coating 160. The magnets 540 shown are very strong magnets as defined above. Suitable magnets are commonly referred to as badge magnets, and they provide ample space for mechanical fixture.

FIG. 7c depicts an alternative method of mechanically fastening the anti-marking jacket to the ribbed cylinder using Velcro® tape. In this embodiment, the Velcro® loop tape is either mechanically sewn or secured using eyelets 340 to the longitudinal edge of the anti-marking cover described above. FIG. 7d illustrates diagrammatically the Velcro® anti-marking cover with the textured surface on the rear side of the diagram as shown. The textured surface 110 is preferably coated with an ink repellent coating 160. The Velcro® hook is adhesively adhered to the inside lip of the cleaned ribbed cylinder. This Velcro® hook mechanically secures the Velcro® loop side from the anti-marking cover as shown in FIG. 7d.

One skilled the art will also recognize many alternatives for mounting the covering to transfer cylinders. Magnets, Velcro® tape, or other suitable means may be alternatively used. Alternatively, an economical method of fastening the prefector anti-marking cover to the perfector cylinder's lip is to mechanically affix Velcro® hook to the rear side of the preferred magnet and sew Velcro® loop to the longitudinal edge of the anti-marking cover. This creates a reusable system for an expensive part that is typically thrown out.

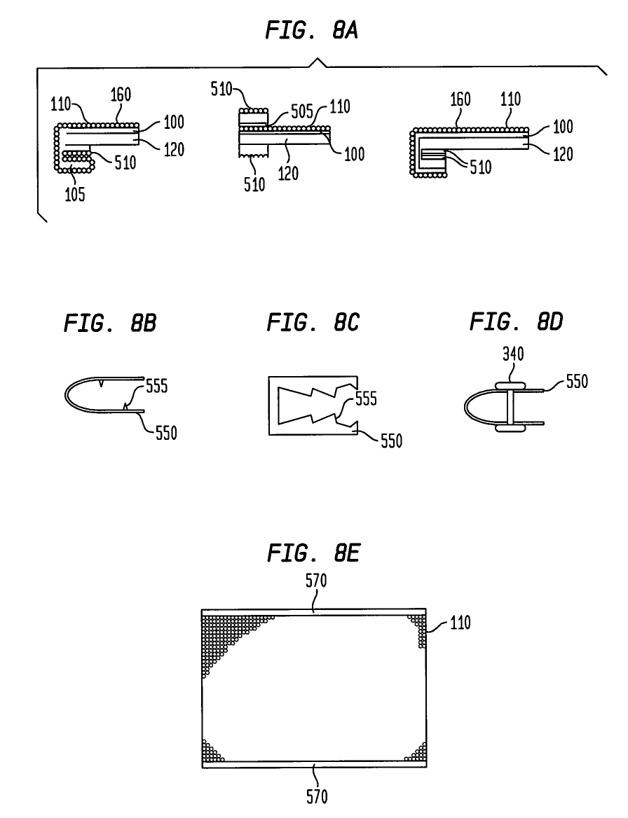

FIG. 8a is a cross sectional view illustrating various ways that a longitudinal edge may be folded upon itself, with or without the addition of anti-skid tape and adhesive for bonding. The primary purpose of these various longitudinal edge preparations is to allow a mechanical fixture to fit securely once the fixture is compressed with a mechanical break so that the anti-marking cover cannot be pulled out during installation. Further to the edge preparation, the mechanical fixtures 550 depicted in FIGS. 8b, 8c, and 8d are the preferred rigid materials since they also afford increased security so the longitudinal edge of the anti-marking jacket cannot be pulled out during installation.

One of the additional benefits of this embodiment is that the form fit between the microcellular layer 120 that compresses and provides for an air tight seal with cylinder's surface. A ⅜″ inch to ½″ strip of anti-skid tape 510 is preferably adhered to one or more faces (120, 110) of the anti-marking longitudinal edge as shown in FIG. 8a. This adds both physical bulk as well as mechanical gripping during compression of the rigid fixture. An unexpected benefit is that the grit also provides lateral stability during mounting, aiding in mechanically preventing the longitudinal edge from being pulled out of the rigid bar during installation. FIG. 8b depicts a metal bar 550 that is manufactured with punched in teeth 555 to securely grip the anti-marking sheet when the leading edge of FIG. 8a is inserted and a mechanical break compresses the bar profile together. FIG. 8c depicts a metal bar 550 that is extruded with teeth 555 to securely grip the anti-marking sheet when the leading edge of FIG. 8a is inserted and a mechanical break compresses the bar profile together. FIG. 8d depicts a metal bar that is made from sheet metal and bent to accommodate the anti-marking sheet when the leading edge of FIG. 8a is inserted and a mechanical break compresses the bar profile together, and either during or after this step a metal rivet or eyelet is inserted for added mechanical security.

FIG. 8e is a diagram of an anti-marking cover with mechanical bar fixtures. This cover typically fits directly onto the blanket or coater cylinder and is used to prevent marking of the freshly inked sheet as it passed through that station. In yet another embodiment, this jacket is used on a press that perfects, in particular on the cylinders on and following the perfector station. The result is a mark free transfer of the wet inked sheet from one print station to the next.

In another embodiment, the “V” or “U” shaped stiffening strip can be dimpled prior to spot welding. The dimple can either be sharp as depicted in FIG. 8b, or dull with the protruding part made slightly smaller or the same size as a corresponding die cut through the flexible substrate being mechanically fixed. The die cut hole and dimple aides in the alignment of both the two pieces and improves the strength of the spot weld.

Anti-marking covers for press cylinders for small, medium and large sheet fed presses made by Shinohara, Ryobi, Mitsubishi and Komori may be readily fabricated using the same two plus layer system coupled with the mechanical fastening method of the present invention, or in sheet form using pressure sensitive adhesive backing.

In accordance with a still further embodiment, the mechanical fasteners can be placed on an anti-marking cover that further provides a mechanical fixture such as Velcro® mounted along on at least one longitudinal edge, or inward from a longitudinal edge, to mount a second flexible textured layer. In one embodiment, this second flexible textured layer can be a woven fabric commonly known as gauze or cheesecloth which acts as the Velcro® loop and easily attaches to Velcro® hook mounted thereon the exterior of the anti-marking cover. In another embodiment, this second flexible textured layer is a non woven fabric referred to above as Evolon™. In yet another embodiment, this second flexible textured layer contains glass beads. Where necessary, it is understood that the mating Velcro® pair may be sewn or attached to the second textured layer for an improved mechanical bond. In all cases, ink repellent coatings are preferably added to the textured layer's surface and anti-static coatings may be added to prevent static buildup from either the freshly printed sheets movement through the press, or from any minor relative movement of the second outer textured substrate.

In yet another embodiment, the mechanical fasteners can be placed on an anti-marking cover consisting of an inner flexible material that is a microfiber fabric such as Evolon™ or a woven fabric, with an outer textured flexible layer, preferably a glass bead layer, disposed thereon. In such an embodiment, the stiffening strip can be mechanically fastened to the inner flexible material (alone or in combination with the outer textured flexible layer) where the inner material is sufficiently strong to provide fastening to the cylinder.

In this embodiment, the anti-marking cover can have two or three layers. For example, the fabric can be covered with a smooth surface such as a vinyl PVC, graphite, non stick coatings like PTFE or silicone. A mechanical fixture such as Velcro® mounted along on at least one longitudinal edge of this embodiment is used to mount a flexible textured layer. When a glass beaded layer is provided on the fabric inner flexible material (forming a first textured flexible layer in this embodiment) as described above, then the second textured layer is optional. In one embodiment, this second flexible textured layer can be a woven fabric commonly known as cheesecloth whose longitudinal edges acts as the Velcro® loop and easily attach to Velcro® hook mounted thereon the exterior of the present inventions anti-marking cover, and even the underside of the actual transfer cylinder itself. In another embodiment, this second flexible textured layer is a non woven fabric such as Evolon™. Woven fabrics that are much tighter than gauze/cheesecloth and which are treated with ink repellency coatings are effective alternatives. In yet another embodiment, this second flexible textured layer contains glass beads. Where necessary, it is understood that the mating velcro® pair may be sewn or attached to the second textured layer for an improved mechanical bond. Velcro may be attached directly to the second textured layers longitudinal edge, or a stiffening strip may be used to improve the fit and simplify the attachment of the otherwise flimsy substrate to the transfer cylinder's anti-marking cover. In all cases, ink repellent coatings are preferably added to the second textured layer's surface and anti-static coatings may be added to prevent static buildup from either the freshly printed sheets movement through the press, or from any minor relative movement of the outer textured substrate.

A person of ordinary skill in the art will appreciate further features and advantages of the invention based on the above-described embodiments. For example, various elements and concepts employed in the embodiments described above may be intermixed in an anti-marking product for use anywhere that sheets having wet ink are transported within the spirit of the present invention. Accordingly, the invention is not to be limited by what has been particularly shown and described, except as indicated by the appended claims. All publications and references cited herein are expressly incorporated herein by reference in their entity.

1. A flexible anti-marking system that is resilient to compressive forces for use on a printing press transfer cylinder, comprising:
an outer flexible substrate layer having a textured surface protruding from a first side for supporting the freshly printed sheet material, and a back side opposed to the first side;
an inner flexible material that is resilient to compressive forces having an outer surface disposed in contact with the back side of the outer flexible substrate layer and an inner surface for contacting the transfer cylinder;
a stiffening strip mechanically fastened to the outer flexible substrate layer on a longitudinal edge portion;
whereby the anti-marking system includes a stiffened longitudinal edge for fixturing to the transfer cylinder, the stiffened longitudinal edge comprising the stiffening strip and the longitudinal edge portion of the outer flexible substrate.

2. The system of claim 1, wherein the inner flexible material is further disposed so as not to contact the back side of the outer flexible substrate along the longitudinal edge portion of the back side.

3. The system of claim 1, wherein the stiffening strip is mechanically fastened to the outer flexible substrate on a longitudinal edge of the backside.

4. The system of claim 1, wherein the inner flexible material is a microcellular material.

5. The system of claim 1, wherein the stiffening strip is a semi-rigid strip of material comprising at least one selected from the group consisting of plastic and metal.

6. The system of claim 5, wherein the stiffening strip is a semi-rigid strip of stainless steel.

7. The system of claim 1, wherein the stiffening strip has a thickness of between about one third and six times thickness of the outer flexible substrate layer.

8. The system of claim 1, wherein the stiffening strip has a thickness between about 1 and 24 thousandths of an inch.

9. The system of claim 1, wherein the stiffening strip is mechanically fastened to the outer flexible substrate layer using at least one fastener selected from the group consisting of a rivet or an eyelet.

10. The system of claim 9, wherein the at least one fastener includes an eyelet that is flattened on each of two opposed sides.

11. The system of claim 9, wherein the at least one fastener includes a rivet.

12. The system of claim 9, wherein where in the at least one fastener includes an eyelet having a flange diameter that is greater than or equal to about 1.5 times a barrel diameter.

13. The system of claim 1, wherein the stiffening strip is mechanically fastened to the outer flexible substrate layer by welding.

14. The system of claim 13, wherein the welding is spot welding.

15. The system of claim 13, wherein the welding is ultrasonic welding.

16. The system of claim 1, wherein the textured surface comprises glass beads.

17. The system of claim 16, wherein the textured surface comprising a plurality of partially exposed spheroidally shaped glass beads having exposed convex portions ranging from between about 0.1 to 20 thousandths of an inch.

18. The system of claim 1, wherein the textured surface includes an ink repellent compound.

19. The system of claim 18, wherein the textured surface includes an anti-static compound.

20. The system of claim 19, wherein the anti-static compound includes at least one selected from the group consisting of ionic elements, salts, carbon, graphite, aluminum, silver, nickel, tin, and iron and alloys thereof.

21. The system of claim 1, wherein the textured surface comprises a fabric.

22. The system of claim 21, wherein the fabric exhibits a textured surface.

23. The system of claim 1, wherein the stiffening strip comprises a hook and loop fastener material.

24. The system of claim 23, wherein a reusable connecting bar is fastened to the hook and loop fastener material.

25. The system of claim 1, wherein a second stiffened longitudinal edge is provided on a longitudinal edge opposite the stiffened longitudinal edge.

26. A transfer system for uniformly supporting a freshly printed sheet material as the freshly printed sheet material is conveyed from a first print station to a next station without marking, the transfer system comprising:
a transfer cylinder having an outer face configured to convey a freshly printed sheet from a first printing station to a next printing station, the cylinder being generally C-shaped and having a longitudinal gap in the outer face to provide access to inner surfaces of the cylinder for attaching an anti-marking covering; and
an anti-marking covering disposed on the outer surface of the transfer cylinder, the anti-marking covering comprising:
an outer flexible substrate layer having a textured surface protruding from a first side for supporting the freshly printed sheet material, and a back side opposed to the first side;
an inner flexible material that is resilient to compressive forces, the inner flexible material having an outer surface disposed in contact with the back side of the outer flexible substrate layer and an inner surface disposed on the outer surface of the transfer cylinder; and
a stiffening strip mechanically fastened to the outer flexible substrate layer on a longitudinal edge portion to form a stiff longitudinal edge for the anti-marking covering;
wherein the anti-marking covering is attached to an inner surface of the transfer cylinder along its stiff longitudinal edge.

27. The system of claim 26, wherein the stiffening strip is even with or below the outer surface of the transfer cylinder.

28. The system of claim 26, wherein the stiffening strip is mechanically fastened to the outer flexible substrate on a longitudinal edge of the backside.

29. The system of claim 26, wherein the inner flexible material is a microcellular material.

30. The system of claim 26, wherein the inner flexible material is further disposed so as not to contact the back side of the outer flexible substrate along the longitudinal edge portion of the back side.

31. The system of claim 26, wherein the anti-marking covering bends from the inner surface of the transfer cylinder into contact with the outer surface of the transfer cylinder.

32. The system of claim 26, wherein the inner surface of the cylinder includes pins that interlock with holes in the stiffened longitudinal edge.

33. The system of claim 26, wherein the inner surface of the cylinder includes a clamp for holding the stiffened longitudinal edge.

34. The system of claim 26, wherein the stiffening strip is a semi-rigid strip of material comprising at least one selected from the group consisting of plastic and metal.

35. The system of claim 34, wherein the stiffening strip is a semi-rigid strip of stainless steel.

36. The system of claim 26, wherein the stiffening strip has a thickness of between about one third and six times thickness of the outer flexible substrate layer.

37. The system of claim 26, wherein the stiffening strip has a thickness between about 1 and 24 thousandths of an inch.

38. The system of claim 26, wherein the stiffening strip is mechanically fastened to the outer flexible substrate layer using at least one fastener selected from the group consisting of a rivet or an eyelet.

39. The system of claim 38, wherein the at least one fastener includes an eyelet that is flattened on each of two opposed sides.

40. The system of claim 38, wherein the at least one fastener includes a rivet.

41. The system of claim 38, wherein where in the at least one fastener includes an eyelet having a flange diameter that is greater than or equal to about 1.5 times a barrel diameter.

42. The system of claim 26, wherein the stiffening strip is mechanically fastened to the outer flexible substrate layer by welding.

43. The system of claim 42, wherein the welding is spot welding.

44. The system of claim 42, wherein the welding is ultrasonic welding.

45. The system of claim 26, wherein the textured surface comprises glass beads.

46. The system of claim 45, wherein the textured surface comprising a plurality of partially exposed spheroidally shaped glass beads having exposed convex portions ranging from between about 0.1 to 20 thousandths of an inch.

47. The system of claim 26, wherein the textured surface includes an ink repellent compound.

48. The system of claim 47, wherein the textured surface includes an anti-static compound.

49. The system of claim 48, wherein the anti-static compound includes at least one selected from the group consisting of ionic elements, salts, carbon, graphite, aluminum, silver, nickel, tin, and iron and alloys thereof.

50. The system of claim 26, wherein the textured surface comprises a fabric.

51. The system of claim 50, wherein the fabric exhibits a textured surface.

52. The system of claim 26, wherein the stiffening strip comprises a hook and loop fastener material.

53. The system of claim 52, wherein a reusable connecting bar is fastened to the hook and loop fastener material.

54. The system of claim 26, wherein a second stiffened longitudinal edge is provided on a longitudinal edge opposite the stiffened longitudinal edge.

55. The system of claim 56, wherein the anti-marking covering is adhered to the outer surface of the transfer cylinder with an adhesive.

56. A method of manufacturing a flexible anti-marking system that is resilient to compressive forces for use on a printing press transfer cylinder, comprising:
providing an outer flexible substrate layer having a textured surface protruding from a first side for supporting the freshly printed sheet material, and a back side opposed to the first side;
laminating an inner flexible material that is resilient to compressive forces into contact with the back side of the outer flexible substrate layer, the inner flexible material including an inner surface for contacting the transfer cylinder and being disposed so as not to contact the backside of the outer flexible substrate along a longitudinal edge portion of the back side;
mechanically fastening a stiffening strip to the outer flexible substrate layer on the longitudinal edge portion;
whereby the anti-marking system includes a stiffened longitudinal edge for fixturing to the transfer cylinder, the stiffened longitudinal edge comprising the stiffening strip and the longitudinal edge of the outer flexible substrate.

57. The method of claim 56, wherein the inner flexible layer is laminated across a full width of the outer flexible substrate layer and the inner flexible layer is then removed from the longitudinal edge portion of the back side.

58. The method of claim 56, wherein the stiffening strip is mechanically fastened to the longitudinal edge portion on the back side.

59. The method of claim 56, wherein the inner flexible material is a microcellular material.

60. The method of claim 56, wherein the stiffening strip is a semi-rigid strip of material comprising at least one selected from the group consisting of plastic and metal.

61. The method of claim 60, wherein the stiffening strip is a semi-rigid strip of stainless steel.

62. The method of claim 56, wherein the stiffening strip has a thickness of between about one third and six times thickness of the outer flexible substrate layer.

63. The method of claim 56, wherein the stiffening strip has a thickness between about 1 and 24 thousandths of an inch.

64. The method of claim 56, wherein the stiffening strip is mechanically fastened to the outer flexible substrate layer using at least one fastener selected from the group consisting of a rivet or an eyelet.

65. The system of claim 64, wherein the at least one fastener includes an eyelet that is flattened on each of two opposed sides.

66. The system of claim 64, wherein the at least one fastener includes a rivet.

67. The system of claim 64, wherein where in the at least one fastener includes an eyelet having a flange diameter that is greater than or equal to about 1.5 times a barrel diameter.

68. The method of claim 56, wherein the stiffening strip is mechanically fastened to the outer flexible substrate layer by welding.

69. The method of claim 68, wherein the welding is spot welding.

70. The method of claim 68, wherein the welding is ultrasonic welding.

71. The method of claim 56, wherein the textured surface comprises glass beads.

72. The method of claim 71, wherein the textured surface comprising a plurality of partially exposed spheroidally shaped glass beads having exposed convex portions ranging from between about 0.1 to 20 thousandths of an inch.

73. The method of claim 56, wherein the textured surface includes an ink repellent compound.

74. The method of claim 73, wherein the textured surface includes an anti-static compound.

75. The method of claim 74, wherein the anti-static compound includes at least one selected from the group consisting of ionic elements, salts, carbon, graphite, aluminum, silver, nickel, tin, and iron and alloys thereof.

76. The method of claim 56, wherein the textured surface comprises a fabric.

77. The method of claim 76, wherein the fabric exhibits a textured surface.

78. The method of claim 56, wherein the stiffening strip comprises a hook and loop fastener material.

79. The method of claim 78, wherein a reusable connecting bar is fastened to the hook and loop fastener material.

80. The method of claim 56, wherein a second stiffened longitudinal edge is provided on a longitudinal edge opposite the stiffened longitudinal edge.

81. A method of preparing a transfer system for uniformly supporting a freshly printed sheet material as the freshly printed sheet material is conveyed from a first print station to a next station without marking, comprising:
providing a transfer cylinder for conveying a freshly printed sheet from a first printing station to a next printing station, the cylinder having an outer face and being generally C-shaped and having a longitudinal gap in the outer face to provide access to inner surfaces of the cylinder for attaching an anti-marking covering;
manufacturing an anti-marking covering, comprising:
providing an outer flexible substrate layer having a textured surface protruding from a first side for supporting the freshly printed sheet material, and a back side opposed to the first side;
laminating an inner flexible material that is resilient to compressive forces into contact with the back side of the outer flexible substrate layer, the inner flexible material including an inner surface for contacting the transfer cylinder and being disposed so as not to contact the backside of the outer flexible substrate along a longitudinal edge portion of the back side;
mechanically fastening a stiffening strip to the outer flexible substrate layer on the longitudinal edge portion to form a stiff longitudinal edge for the anti-marking covering;
attaching the anti-marking covering to an inner surface of the transfer cylinder along its stiff longitudinal edge.

82. The method of claim 81, wherein the stiffening strip is even with or below the outer surface of the transfer cylinder.

83. The method of claim 81, wherein the anti-marking covering bends from the inner surface of the transfer cylinder into contact with the outer surface of the transfer cylinder.

84. The method of claim 81, wherein the inner surface of the cylinder includes pins that interlock with holes in the stiffened longitudinal edge.

85. The method of claim 81, wherein the inner surface of the cylinder includes a clamp for holding the stiffened longitudinal edge.

86. The method of claim 81, wherein the inner flexible layer is laminated across a full width of the outer flexible substrate layer and the inner flexible layer is then removed from the longitudinal edge portion of the back side.

87. The method of claim 81, wherein the stiffening strip is mechanically fastened to the longitudinal edge portion on the back side.

88. The method of claim 81, wherein the inner flexible material is a microcellular material.

89. The method of claim 81, wherein the stiffening strip is a semi-rigid strip of material comprising at least one selected from the group consisting of plastic and metal.

90. The method of claim 89, wherein the stiffening strip is a semi-rigid strip of stainless steel.

91. The method of claim 81, wherein the stiffening strip has a thickness of between about one third and six times thickness of the outer flexible substrate layer.

92. The method of claim 81, wherein the stiffening strip has a thickness between about 1 and 24 thousandths of an inch.

93. The method of claim 81, wherein the stiffening strip is mechanically fastened to the outer flexible substrate layer using at least one fastener selected from the group consisting of a rivet or an eyelet.

94. The method of claim 81, wherein the at least one fastener includes an eyelet that is flattened on each of two opposed sides.

95. The method of claim 81, wherein the at least one fastener includes a rivet.

96. The method of claim 81, wherein where in the at least one fastener includes an eyelet having a flange diameter that is greater than or equal to about 1.5 times a barrel diameter.

97. The method of claim 81, wherein the stiffening strip is mechanically fastened to the outer flexible substrate layer by welding.

98. The method of claim 97, wherein the welding is spot welding.

99. The method of claim 97, wherein the welding is ultrasonic welding.

100. The method of claim 81, wherein the textured surface comprises glass beads.

101. The method of claim 100, wherein the textured surface comprising a plurality of partially exposed spheroidally shaped glass beads having exposed convex portions ranging from between about 0.1 to 20 thousandths of an inch.

102. The method of claim 81, wherein the textured surface includes an ink repellent compound.

103. The method of claim 102, wherein the textured surface includes an anti-static compound.

104. The method of claim 103, wherein the anti-static compound includes at least one selected from the group consisting of ionic elements, salts, carbon, graphite, aluminum, silver, nickel, tin, and iron and alloys thereof.

105. The method of claim 81, wherein the textured surface comprises a fabric.

106. The method of claim 105, wherein the fabric exhibits a textured surface.

107. The method of claim 81, wherein the stiffening strip comprises a hook and loop fastener material.

108. The method of claim 107, wherein a reusable connecting bar is fastened to the hook and loop fastener material.

109. The method of claim 81, wherein a second stiffened longitudinal edge is provided on a longitudinal edge opposite the stiffened longitudinal edge.

110. A method for transferring a freshly printed sheet from one printing station to the next, comprising:
providing a transfer cylinder configured to convey a freshly printed sheet from a first printing station to a next printing station, the cylinder having an outer face and being generally C-shaped with a longitudinal gap in the outer face to provide access to inner surfaces of the cylinder for attaching an anti-marking covering;
providing an anti-marking covering, comprising:
an outer flexible substrate layer having a textured surface protruding from a first side for supporting the freshly printed sheet material, and a back side opposed to the first side;
an inner flexible material that is resilient to compressive forces disposed in contact with the back side of the outer flexible substrate layer, the inner flexible material including an inner surface for contacting the transfer cylinder; and
a stiffening strip mechanically fastened to the outer flexible substrate layer on a longitudinal edge portion to form a stiff longitudinal edge for the anti-marking covering;
attaching the anti-marking covering to an inner surface of the transfer cylinder along its stiff longitudinal edge; and
receiving a printed sheet from a first printing station on the textured surface and transferring the sheet to a second printing station for further printing.

111. The method of claim 110, wherein the stiffening strip is even with or below the outer surface of the transfer cylinder.

112. The method of claim 110, wherein the anti-marking covering bends from the inner surface of the transfer cylinder into contact with the outer surface of the transfer cylinder.

113. The method of claim 110, wherein the inner surface of the cylinder includes pins that interlock with holes in the stiffened longitudinal edge.

114. The method of claim 110, wherein the inner surface of the cylinder includes a clamp for holding the stiffened longitudinal edge.

115. The method of claim 110, wherein the inner flexible layer is laminated across a full width of the outer flexible substrate layer and the inner flexible layer is then removed from the longitudinal edge portion of the back side.

116. The method of claim 110, wherein the stiffening strip is mechanically fastened to the longitudinal edge portion on the back side.

117. The method of claim 110, wherein the inner flexible material is a microcellular material.

118. The method of claim 110, wherein the stiffening strip is a semi-rigid strip of material comprising at least one selected from the group consisting of plastic and metal.

119. The method of claim 118, wherein the stiffening strip is a semi-rigid strip of stainless steel.

120. The method of claim 110, wherein the stiffening strip has a thickness of between about one third and six times thickness of the outer flexible substrate layer.

121. The method of claim 110, wherein the stiffening strip has a thickness between about 1 and 24 thousandths of an inch.

122. The method of claim 110, wherein the stiffening strip is mechanically fastened to the outer flexible substrate layer using at least one fastener selected from the group consisting of a rivet or an eyelet.

123. The method of claim 122, wherein the at least one fastener includes an eyelet that is flattened on each of two opposed sides.

124. The method of claim 122, wherein the at least one fastener includes a rivet.

125. The method of claim 122, wherein where in the at least one fastener includes an eyelet having a flange diameter that is greater than or equal to about 1.5 times a barrel diameter.

126. The method of claim 110, wherein the stiffening strip is mechanically fastened to the outer flexible substrate layer by welding.

127. The method of claim 126, wherein the welding is spot welding.

128. The method of claim 126, wherein the welding is ultrasonic welding.

129. The method of claim 110, wherein the textured surface comprises glass beads.

130. The method of claim 129, wherein the textured surface comprising a plurality of partially exposed spheroidally shaped glass beads having exposed convex portions ranging from between about 0.1 to 20 thousandths of an inch.

131. The method of claim 110, wherein the textured surface includes an ink repellent compound.

132. The method of claim 131, wherein the textured surface includes an anti-static compound.

133. The method of claim 132, wherein the anti-static compound includes at least one selected from the group consisting of ionic elements, salts, carbon, graphite, aluminum, silver, nickel, tin, and iron and alloys thereof.

134. The method of claim 110, wherein the textured surface comprises a fabric.

135. The method of claim 134, wherein the fabric exhibits a textured surface.

136. The method of claim 110, wherein the stiffening strip comprises a hook and loop fastener material.

137. The method of claim 136, wherein a reusable connecting bar is fastened to the hook and loop fastener material.

138. The method of claim 110, wherein a second stiffened longitudinal edge is provided on a longitudinal edge opposite the stiffened longitudinal edge.

139. A flexible anti-marking system that is resilient to compressive forces for use on a printing press transfer cylinder, comprising:
an outer flexible substrate layer having a textured surface protruding from a first side for supporting the freshly printed sheet material, and a back side opposed to the first side;
an inner flexible material having an outer surface disposed in contact with the back side of the outer flexible substrate layer and an inner surface for contacting the transfer cylinder;
a stiffening strip mechanically fastened to a longitudinal edge portion of the system, whereby the anti-marking system includes a stiffened longitudinal edge for fixturing to the transfer cylinder, the stiffened longitudinal edge comprising the stiffening strip and the longitudinal edge portion of the outer flexible substrate.

140. The system of claim 139, wherein the inner flexible material is resilient to compressive forces.

141. The system of claim 140, wherein the stiffening strip is mechanically fastened to the outer flexible substrate.

142. The system of claim 140, wherein the inner flexible material is a microcellular foam.

143. The system of claim 139, wherein the stiffening strip is mechanically fastened to the inner flexible material.

144. The system of claim 143, wherein the inner flexible material is a fabric.

145. The system of claim 143, wherein the outer flexible substrate layer having a textured outer face is a fabric.

146. The system of claim 145, wherein the fabric is a woven fabric.

147. The system of claim 145, wherein the fabric is a cheesecloth.

148. The system of claim 145, wherein the outer flexible substrate layer is mechanically fastened to the inner flexible material.

149. The system of claim 148, wherein the outer flexible substrate layer is mechanically fastened to the inner flexible material using a hook and loop fastener.

150. The system of claim 143, wherein the stiffening strip is a semi-rigid strip of material comprising at least one selected from the group consisting of plastic and metal.

151. The system of claim 150, wherein the stiffening strip is a semi-rigid strip of stainless steel.

152. The system of claim 143, wherein the stiffening strip has a thickness between about 1 and 24 thousandths of an inch.

153. The system of claim 143, wherein the stiffening strip is mechanically fastened to the inner flexible material using at least one fastener selected from the group consisting of a rivet or an eyelet.

154. The system of claim 153, wherein the at least one fastener includes an eyelet that is flattened on each of two opposed sides.

155. The system of claim 153, wherein the at least one fastener includes a rivet.

156. The system of claim 153, wherein where in the at least one fastener includes an eyelet having a flange diameter that is greater than or equal to about 1.5 times a barrel diameter.

157. The system of claim 143, wherein the stiffening strip is mechanically fastened to the inner flexible material by welding.

158. The system of claim 157, wherein the welding is spot welding.

159. The system of claim 157, wherein the welding is ultrasonic welding.

160. The system of claim 139, wherein the inner flexible material has an outer textured surface for contacting the outer flexible substrate layer.
